(19) United States
(12) Patent Application Publication
(10) Pub. No.: US 2020/0172811 A1
(43) Pub. Date: Jun. 4, 2020

(54) LIQUID CRYSTAL COMPOSITION AND LIQUID CRYSTAL DISPLAY DEVICE

(71) Applicant: DIC Corporation, Tokyo (JP)

(72) Inventors: Go Sudo, Kita-adachi-gun (JP); Haruki Ohishi, Kita-adachi-gun (JP); Shirou Taniguchi, Kita-adachi-gun (JP); Kazuki Kurisawa, Kita-adachi-gun (JP)

(73) Assignee: DIC Corporation, Tokyo (JP)

(21) Appl. No.: 16/625,977

(22) PCT Filed: Jul. 12, 2018
(86) PCT No.: PCT/JP2018/026291

§ 371 Date: Dec. 23, 2019

(30) Foreign Application Priority Data
Jul. 25, 2017 (JP) 2017-143548

(51) Int. Cl. C09K 19/30

(52) U.S. Cl. CPC C09K 19/3066; C09K 2019/0448

(57) ABSTRACT

A problem to be solved by the present invention is to provide a liquid crystal composition having negative dielectric anisotropy (Δε), large refractive index anisotropy (Δn), a high nematic phase-isotopic liquid phase transition temperature (T_{NI}), a low solid phase-nematic phase transition temperature (T_{CN}), sufficiently low rotational viscosity (γ₁), and large elastic constant (K₃₃), and also to provide a VA-mode, FFS-mode, or IPS-mode liquid crystal display device using the liquid crystal composition, satisfying a high response speed, high VHR, and excellent low-temperature storage stability, and having no or very few display defects. According to the liquid crystal composition of the present invention, the problem is solved by a liquid crystal composition containing compounds represented by general formula (S1), general formula (S2), and general formula (S3).

### TECHNICAL FIELD

The present invention relates to a liquid crystal composition and a liquid crystal display device using the same.

### BACKGROUND ART

Liquid crystal display devices are used for watches and electronic calculators, various household electric appliances, industrial measuring apparatuses, automotive panels, cellular phones, smartphones, notebook PC, tablet PC, televisions, etc. Typical examples of a liquid crystal display mode include a TN (twisted nematic) mode, a STN (super twisted nematic) mode, a GH (guest-host) mode, an IPS (in-plane switching) mode, a FFS (fringe field switching) mode, an OCB (optically compensated birefringence) mode, an ECB (electrically controlled birefringence) mode, a VA (vertical alignment) mode, a CSH (color super-homeotropic) mode, a FLC (ferroelectric liquid crystal) mode, and the like. Examples of a driving method include static driving, multiplex driving, a simple matrix method, and an active matrix (AM) method of driving by using TFT (thin-film transistor), TFD (thin-film diode) or the like. Among these display modes, the IPS mode, the FFS mode, the ECB mode, the VA mode, the CSH mode, or the like is characterized by using a liquid crystal composition showing a negative value of dielectric anisotropy (Δε).

Among these, in particular, the FFS display mode using AM driving is used for applications such as mobile devices, for example, a smartphone, a tablet PC, and the like from the viewpoint of a wide viewing angle, high transmittance, low power consumption, and optimality for a touch panel, and, further, application to a liquid crystal television is advanced.

A liquid crystal composition disclosed as a liquid crystal composition having negative Δε uses liquid crystal compounds (A) and (B) (refer to Patent Literature 1) having a 2,3-difluorophenylene skeleton as shown below.

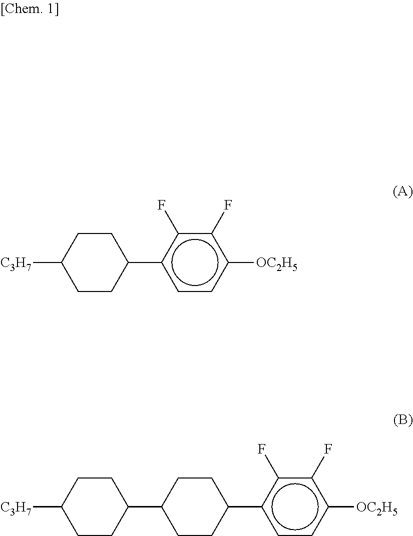

The liquid crystal composition uses liquid crystal compounds (C) and (D) as liquid crystal compounds having substantially zero Δε, but satisfactorily low viscosity is not yet realized with the liquid crystal composition for a liquid crystal television and the like which are required to have fast response.

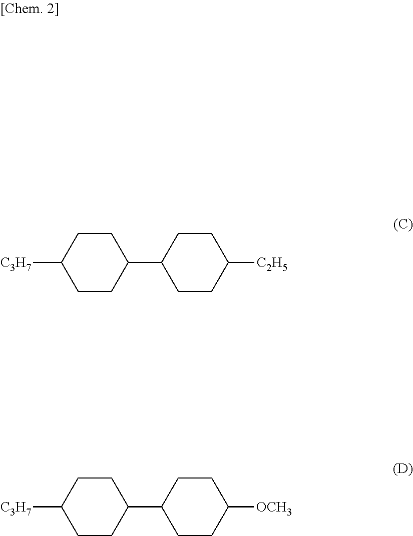

On the other hand, a liquid crystal composition using a liquid crystal compound (E) is already disclosed, but there are introduced a liquid crystal composition combined with the liquid crystal compound (D) and having low refractive index anisotropy Δn (refer to Patent Literature 2) and a liquid crystal composition containing a liquid crystal compound (F) added for improving the response speed (refer to Patent Literature 3).

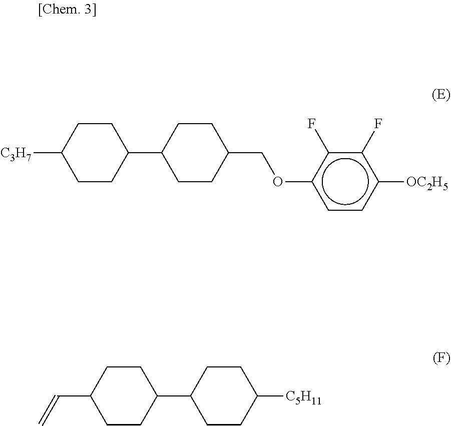

Also, a liquid crystal composition using a liquid crystal compound (G) and a liquid crystal compound (F) is already disclosed (refer to Patent Literature 4), but a higher response speed is required.

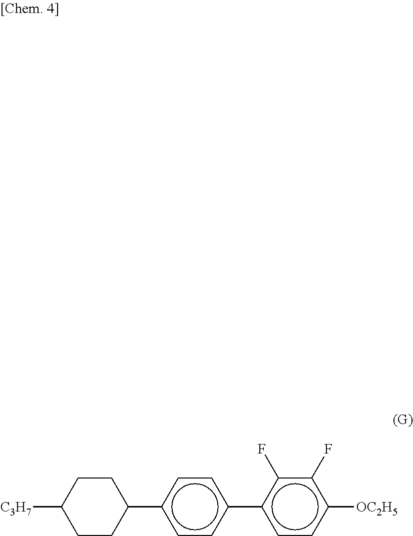

Further, there is disclosed a liquid crystal composition further combined with a liquid crystal compound (I) having high Δn (refer to Patent Literature 5).

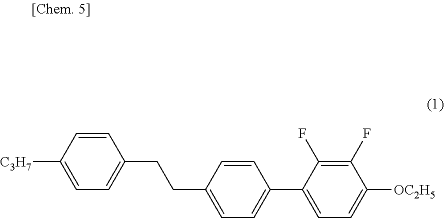

However, a higher response speed and higher voltage holding ratio (VHR) are required.

Therefore, any one of these liquid crystal compositions are quired to satisfy the higher levels of high response speed and high VHR required for a liquid crystal display device.

On the other hand, Patent Literature 6 discloses that the response speed of a homeotropic liquid crystal cell is improved by using a liquid crystal material having a large index represented by (Formula 1). However, the improvement cannot be said satisfactory.

$$\begin{matrix}[ Math . 1 ] & \\ FoM = {K}_{33} \cdot Δ {n}^{2} / γ 1 \\ {K}_{33} \text{:} Elastic constant \\ Δ n \text{:} Refractive index anisotropy \\ γ1 \text{:} Rotational visocity & ( Formula 1 )\end{matrix}$$

Also, liquid crystal compositions required for a cellar phone, a smartphone, a notebook PC, a tablet PC, vehicle-mounted LCD, and the like, which are used outdoors, are required to have a high nematic phase-isotopic liquid phase transition temperature (T_{NI}), a low solid phase-nematic phase transition temperature (T_{CN}), and excellent low-temperature storage stability, and are further required to have sufficiently low rotational viscosity (γ₁), high refractive index anisotropy (Δn), and large elastic constant (K₃₃). Thus, a liquid crystal display device used for these applications are required to simultaneously satisfy a high response speed, high VHR, and excellent low-temperature storage stability (Low Temperature Storage Test).

### CITATION LIST

### Patent Literature

PTL 1: Japanese Unexamined Patent Application Publication No. 8-104869

PTL 2: European Patent Application Publication No. 0474062

PTL 3: Japanese Unexamined Patent Application Publication No. 2006-037054

PTL 4: Japanese Unexamined Patent Application Publication No. 2001-354967

PTL 5: Japanese Unexamined Patent Application Publication No. 2017-52960

PTL 6: Japanese Unexamined Patent Application Publication No. 2006-301643

### SUMMARY OF INVENTION

### Technical Problem

A problem to be solved by the present invention is to provide a liquid crystal composition having negative dielectric anisotropy (Δε), large refractive index anisotropy (Δn), a high nematic phase-isotopic liquid phase transition temperature (T_{NI}), a low solid phase-nematic phase transition temperature (T_{CN}), sufficiently low rotational viscosity (γ₁), and large elastic constant (K₃₃), and also to provide a VA-mode, FFS-mode, or IPS-mode liquid crystal display device using the liquid crystal composition, simultaneously satisfying a high response speed, high VHR, and excellent low-temperature storage stability, and having no or very few display defects.

### Solution to Problem

As a result of earnest investigation, the inventors of the present invention found that the problem can be solved by a liquid crystal composition containing a combination of a compound having a specified chemical structure and a polymerizable compound, leading to the achievement of the present invention.

### Advantageous Effects of Invention

A liquid crystal composition of the present invention can provide a liquid crystal composition having negative Δε, large refractive index anisotropy (Δn), high T_{NI}, low T_{CN}, sufficiently low γ₁, and large K₃₃. Also, by using the liquid crystal composition, it is possible to provide a VA-mode, FFS-mode, or IPS-mode liquid crystal display device simultaneously satisfying a high response speed, high VHR, and excellent low-temperature storage stability, and having no or very few display defects. The liquid crystal display device is particularly suitable for a cellular phone, a smartphone, a notebook PC, a tablet PC, and vehicle LCD, PID (Public Information Display), which are used outdoors, a liquid crystal television, or the like.

### DESCRIPTION OF EMBODIMENTS

The present invention relates to a liquid crystal composition having negative Δε and simultaneously containing one or two or more compounds represented by general formula (S1), one or two or more compounds represented by general formula (S2), and one or two or more compounds represented by general formula (S3),

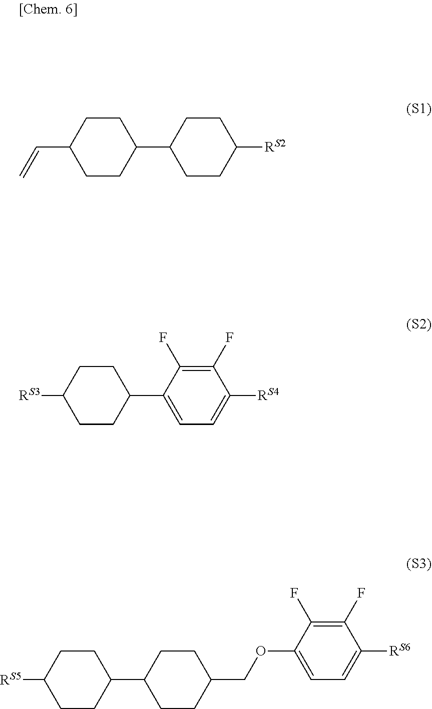

(in the formulae, R^{S2} to R^{S6} each independently represent an alkyl group having 1 to 8 carbon atoms, an alkoxy group having 1 to 8 carbon atoms, an alkenyl group having 2 or 3 carbon atoms, or an alkenyloxy group having 2 or 3 carbon atoms), and further relates to a liquid crystal display device using the liquid crystal composition.

The lower limit value of the content of a compound of the general formula (S1) in the liquid crystal composition of the present invention is preferably 10% by mass, preferably 15% by mass, preferably 20% by mass, more preferably 25% by mass, more preferably 30% by mass, and more preferably 35% by mass, and the upper limit value is preferably 50% by mass, preferably 45% by mass, more preferably 40% by mass, more preferably 35% by mass, and more preferably 30% by mass.

The lower limit value of the content of a compound of the general formula (S2) in the liquid crystal composition of the present invention is preferably 10% by mass, preferably 12% by mass, more preferably 14% by mass, more preferably 15% by mass, more preferably 20% by mass, and more preferably 25% by mass, and the upper limit value is preferably 40% by mass, more preferably 35% by mass, and more preferably 30% by mass.

The lower limit value of the content of a compound of the general formula (S3) in the liquid crystal composition of the present invention is preferably 10% by mass, preferably 15% by mass, preferably 17% by mass, more preferably 19% by mass, more preferably 20% by mass, and more preferably 24% by mass, and the upper limit value is preferably 40% by mass, more preferably 35% by mass, and more preferably 30% by mass.

The compound represented by the general formula (S1) is preferably a compound represented by formula (S1-1), formula (S1-2), or formula (S1-3).

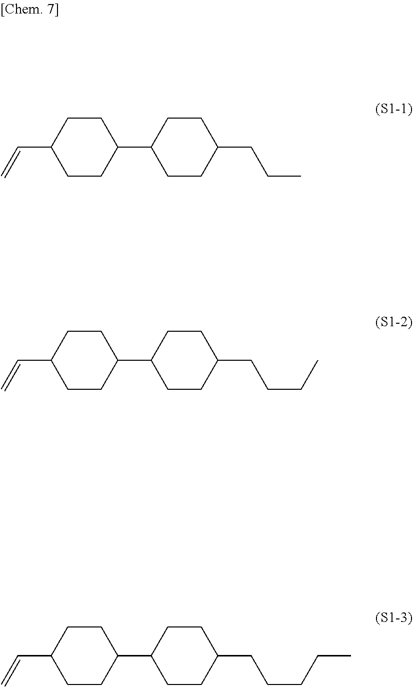

The liquid crystal composition of the present invention particularly preferably contains a compound represented by the formula (S1-1) as the compound represented by the general formula (S1).

The compound represented by the general formula (S2) is preferably a compound represented by formula (S2-1), formula (S2-2), formula (S2-3), or formula (S2-4).

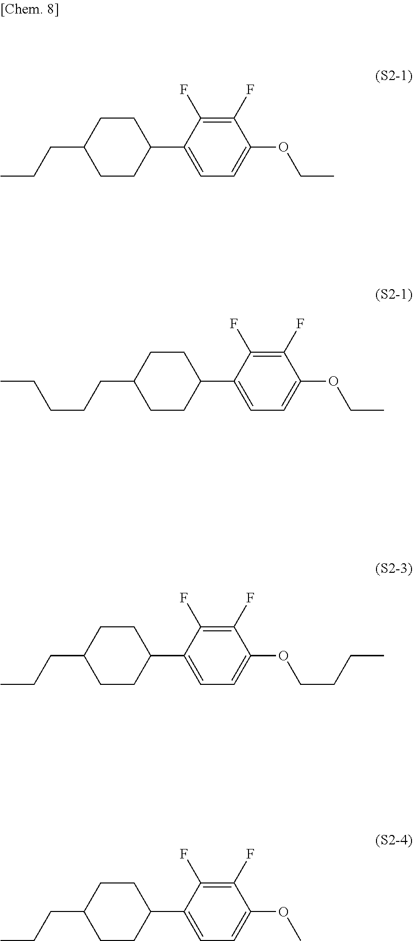

The liquid crystal composition of the present invention preferably contains a compound represented by the formula (S2-1) as the compound represented by the general formula (S2).

The liquid crystal composition of the present invention preferably contains a compound represented by the formula (S2-2) as the compound represented by the general formula (S2).

The liquid crystal composition of the present invention preferably contains a compound represented by the formula (S2-3) as the compound represented by the general formula (S2).

The liquid crystal composition of the present invention preferably contains a compound represented by the formula (S2-4) as the compound represented by the general formula (S2).

The liquid crystal composition of the present invention more preferably contains a compound represented by the formula (S2-1) and a compound represented by the formula (S2-2) as the compound represented by the general formula (S2).

The liquid crystal composition of the present invention preferably contains a compound represented by the formula (S2-1) and a compound represented by the formula (S2-3) as the compound represented by the general formula (S2).

The liquid crystal composition of the present invention preferably contains a compound represented by the formula (S2-1) and a compound represented by the formula (S2-4) as the compound represented by the general formula (S2).

The liquid crystal composition of the present invention preferably contains a compound represented by the formula (S2-3) and a compound represented by the formula (S2-4) as the compound represented by the general formula (S2).

The compound represented by the general formula (S3) is preferably a compound represented by general formula (S3-1), general formula (S3-2), general formula (S3-3), general formula (S3-4), or general formula (S3-5).

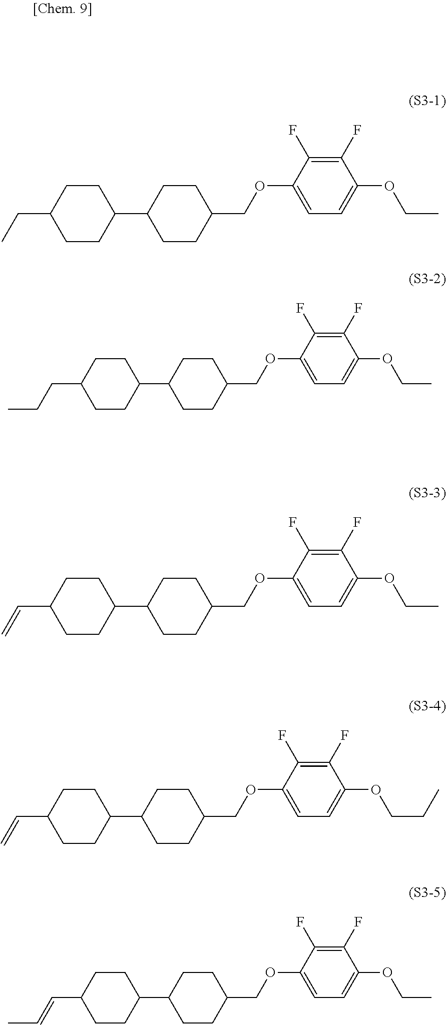

The liquid crystal composition of the present invention preferably contains a compound represented by the formula (S3-1) as the compound represented by the general formula (S3).

The liquid crystal composition of the present invention preferably contains a compound represented by the formula (S3-2) as the compound represented by the general formula (S3).

The liquid crystal composition of the present invention preferably contains a compound represented by the formula (S3-3) as the compound represented by the general formula (S3).

The liquid crystal composition of the present invention preferably contains a compound represented by the formula (S3-4) as the compound represented by the general formula (S3).

The liquid crystal composition of the present invention preferably contains a compound represented by the formula (S3-5) as the compound represented by the general formula (S3).

The liquid crystal composition of the present invention more preferably contains a compound represented by the formula (S3-1) and a compound represented by the formula (S3-2) as the compound represented by the general formula (S3).

The liquid crystal composition of the present invention preferably contains a compound represented by the formula (S3-2) and a compound represented by the formula (S3-3) as the compound represented by the general formula (S3).

The liquid crystal composition of the present invention preferably contains a compound represented by the formula (S3-2) and a compound represented by the formula (S3-5) as the compound represented by the general formula (S3).

The liquid crystal composition of the present invention preferably contains a compound represented by the formula (S3-3) and a compound represented by the formula (S3-4) as the compound represented by the general formula (S3).

The liquid crystal composition of the present invention preferably contains a compound represented by the formula (S3-3) and a compound represented by the formula (33-5) as the compound represented by the general formula (S3).

The liquid crystal composition of the present invention particularly preferably contains a compound represented by the formula (S3-3), a compound represented by the formula (S3-4), and a compound represented by the formula (S3-5) as the compound represented by the general formula (S3).

The liquid crystal composition of the present invention preferably further contains one or two or more compounds selected from a compound group represented by general formulae (N-01), (N-02), (N-03), and/or (N-04),

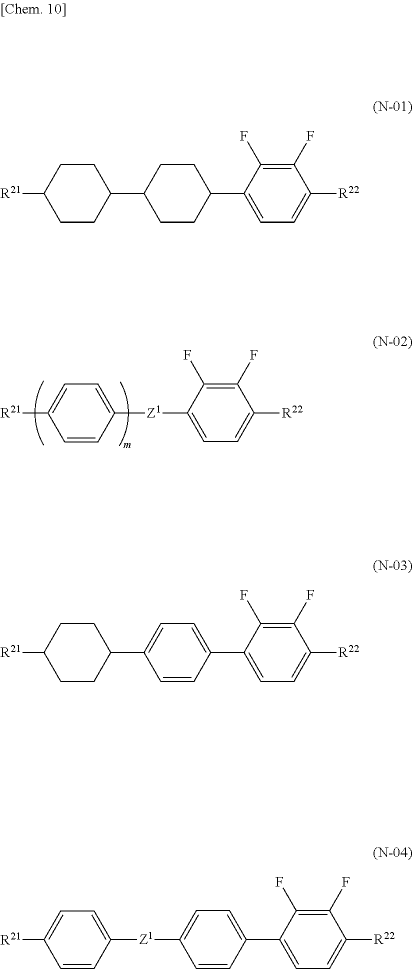

(in the formulae, R²¹ and R²² each independently represent an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, in which one or two or more unadjacent —CH₂— in the group may be independently substituted by —CH═CH—, —C≡C—, —O—, —CO—, —COO—, or —OCO—; Z¹ each independently represent a single bond, —CH₂CH₂—, —OCH₂—, —CH₂O—, —COO—, —OCO—, —OCF₂—, —CF₂O—, —CH═CH—, —CF═CF—, or —C≡C—; and m each independently represent 1 or 2, but exclude compounds represented by the general formulae (S2) and (S3)).

The compounds represented by the general formulae (N-01), (N-02), (N-03), and/or (N-04) have negative dielectric anisotropy (Δε) and show its absolute value of more than 2. In addition, Δε is a value extrapolated from the measured value of dielectric anisotropy of a composition prepared by adding the compound to a composition substantially dielectrically neutral at 25° C.

R²¹ is preferably an alkyl group having 1 to 8 carbon atoms, more preferably an alkyl group having 1 to 5 carbon atoms, and still more preferably an alkyl group having 1 to 4 carbon atoms. However, when Z¹ represents other than a single bond, R²¹ is preferably an alkyl group having 1 to 3 carbon atoms.

R²² is preferably an alkyl group having 1 to 8 carbon atoms or alkoxy group having 1 to 8 carbon atoms, more preferably an alkyl group having 1 to 5 carbon atoms or an alkoxy group having 1 to 4 carbon atoms, and still more preferably an alkoxy group having 1 to 4 carbon atoms.

When R²¹ and R²² are each an alkenyl group, the group is preferably selected from groups represented by formula (R1) to formula (R5) (in each of the formulae, a black point represents a carbon atom in a ring structure), and the formula (R1) or formula (R2) is preferred. In detail, when low rotational viscosity (γ1) is regarded as important, the formula (R1) is preferred, while when high (Tni) or a high elastic constant (K33) is regarded as important, the formula (R2) is preferred.

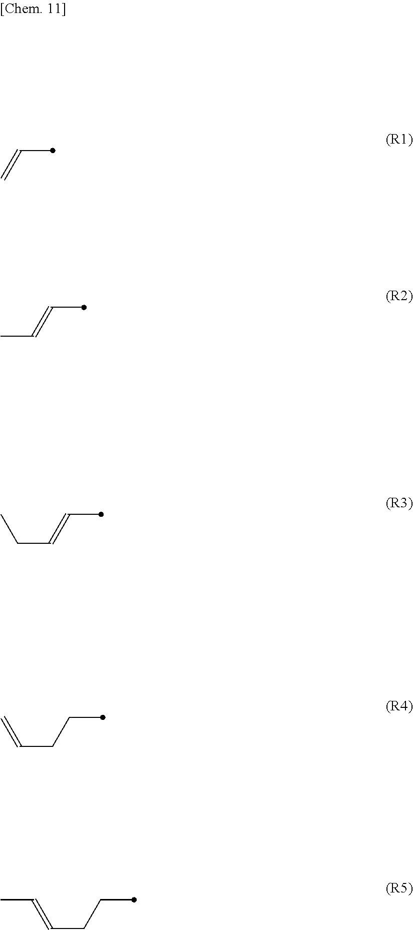

Z¹ each independently represent a single bond, —CH₂CH₂—, —OCH₂—, —CH₂O—, —COO—, —OCO—, —OCF₂—, —CF₂O—, —CH═CH—, —CF═CF—, or —C≡C—, but is preferably a single bond, —CH₂CH₂—, —OCH₂—, or —CH₂O—, and more preferably a single bond, —CH₂CH₂—, or —CH₂O—.

In the general formula (N-01), R²¹ is preferably an alkyl group having 2 to 4 carbon atoms or an alkenyl group having 2 or 3, and R²² is preferably an alkoxy group having 1 to 4 carbon atoms.

In the general formula (N-02), Z¹ is preferably a single bond, m is preferably 1, R²¹ is preferably an alkyl group having 2 to 4, and R²² is preferably an alkoxy group having 1 to 4 carbon atoms.

In the general formula (N-03), R²¹ is preferably an alkyl group having 1 to 4 carbon atoms or an alkenyl group having 2 or 3, and R²² is preferably an alkoxy group having 1 to 4 carbon atoms.

In the general formula (N-04), Z¹ is preferably —CH₂CH₂—, R²¹ is preferably an alkyl group having 1 to 4 carbon atoms, and R²² is preferably an alkoxy group having 1 to 4 carbon atoms.

A fluorine atom in a compound represented by each of the general formulae (N-01), (N-02), (N-03), and (N-04) may be substituted by a chlorine atom in the same halogen group. However, the content of a compound substituted by a chlorine atom is preferably as low as possible, and such a compound is more preferably not contained.

A hydrogen atom in a ring of a compound represented by each of the general formulae (N-01), (N-02), (N-03), and (N-04) may be further substituted by a fluorine atom or a chlorine atom. However, the content of a compound substituted by a chlorine atom is preferably as low as possible, and such a compound is more preferably not contained.

The compound represented by each of the general formulae (N-01), (N-02), (N-03), and (N-04) is preferably a compound having negative Δε and its absolute value of more than 3.

A compound contained as the compound represented by the general formula (N-02) is preferably one or two or more compounds selected from a compound group represented by general formula (N-02-1), general formula (N-02-2), and general formula (N-02-3).

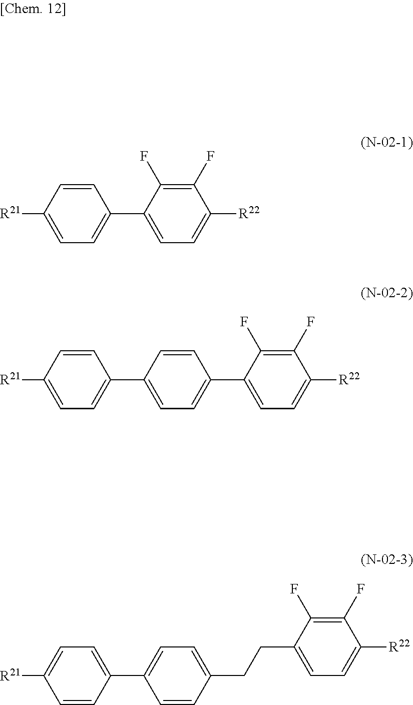

(R²¹ and R²² each independently represent an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, in which one or two or more unadjacent —CH₂— in the group may be independently substituted by —CH═CH—, —C≡C—, —O—, —CO—, —COO—, or —OCO—).

R²¹ is preferably independently an alkyl group having 1 to 4 carbon atoms, and R²² is preferably an alkoxy group having 1 to 4.

Also, the liquid crystal composition of the present invention preferably contains a compound represented by general formula (N-02-3).

The compound represented by the general formula (N-04) is preferably one or two or more compounds represented by general formula (N-04-1),

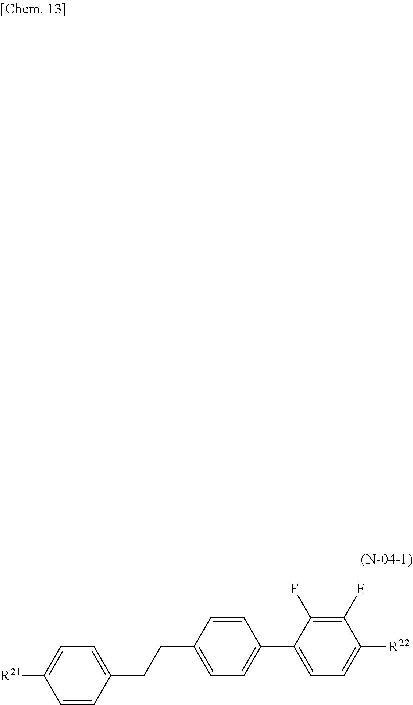

(in the formula, R²¹ and R²² each independently represent an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, in which one or two or more unadjacent —CH₂— in the group may be independently substituted by —CH═CH—, —C≡C—, —O—, —CO—, —COO—, or —OCO—).

In the general formula (N-04-1), R²¹ is preferably an alkyl group having 1 to 4 carbon atoms, and R²³ is preferably an alkoxy group having 1 to 4.

The liquid crystal composition of the present invention particularly preferably contains a compound represented by the general formula (N-04-1).

The lower limit of the preferred content of the compound represented by the general formula (N-01) relative to the total amount of the liquid crystal composition of the present invention is 0%, 1%, 5%, or 10%, and the upper limit relative to the total amount of the liquid crystal composition of the present invention is 10% or 5%.

The lower limit of the preferred content of the compound represented by the general formula (N-02) relative to the total amount of the liquid crystal composition of the present invention is 0%, 1%, 5%, or 10%, and the upper limit relative to the total amount of the liquid c3rystal composition of the present invention is 10% or 5%.

The lower limit of the preferred content of the compound represented by the general formula (N-03) relative to the total amount of the liquid crystal composition of the present invention is 0%, 1%, 5%, or 10%, and the upper limit relative to the total amount of the liquid c3rystal composition of the present invention is 10% or 5%.

The lower limit of the preferred content of the compound represented by the general formula (N-04) relative to the total amount of the liquid crystal composition of the present invention is 0%, 1%, 5%, or 10%, and the upper limit relative to the total amount of the liquid crystal composition of the present invention is 30%, 25%, 20%, or 15%.

Also, the liquid crystal composition of the present invention may further contain one or two or more compounds represented by general formula (N-05).

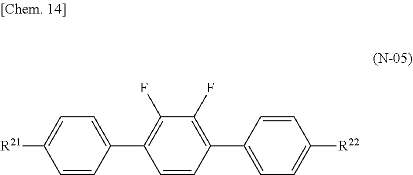

(In the formula, R²¹ and R²² preferably each independently represent an alkyl group having 1 to 4 carbon atoms or an alkenyl group represented by the formula (R4) or formula (R5)).

The compound represented by the general formula (N-05) may also be used when various physical properties are desired to be adjusted.

The lower limit value of the preferred content of the compound represented by the formula (N-05) relative to the total amount of the liquid crystal composition of the present invention is 0%, 2%, or 5%, and the upper limit relative to the total amount of the liquid crystal composition of the present invention is 15% or 10%.

The compound represented by the general formula (N-05) is preferably a compound selected from a compound group represented by formula (N-05-1) to formula (N-05-3).

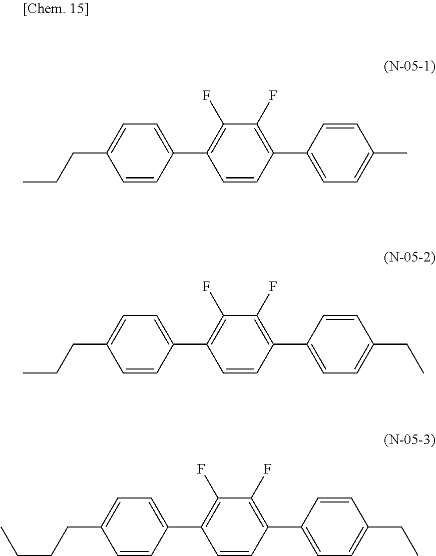

The liquid crystal composition of the present invention may further contain one or two or more compounds represented by general formula (N-06).

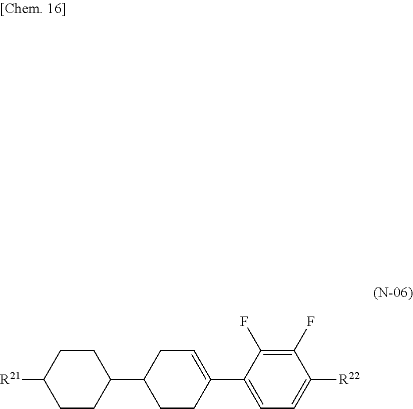

(In the formula, R²¹ and R²² each represent the same meaning as described above.)

The liquid crystal composition of the present invention preferably does not contain a compound represented by the formula (N-06).

The liquid crystal composition of the present invention contains, as a compound having substantially zero Δε, one or two or more compounds selected from a compound group represented by general formula (NU-01) to general formula (NU-06).

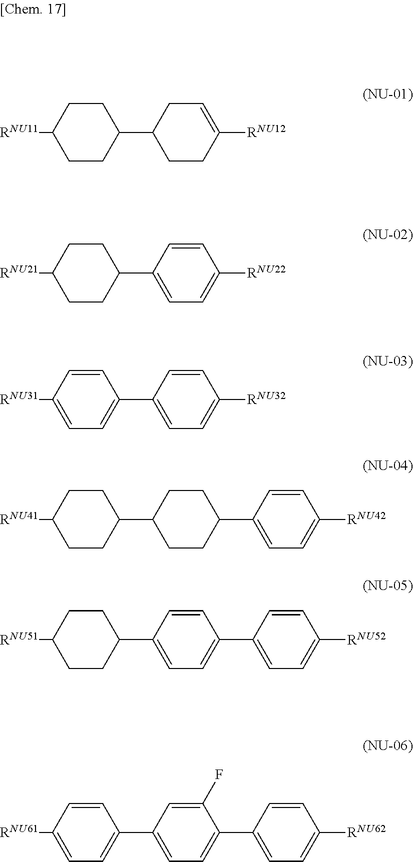

(In the formulae, R^{NU11}, R^{NU12}, R^{NU21}, R^{NU22}, R^{NU31}, R^{NU32}, R^{NU41}, R^{NU42}, R^{NU51}, R^{NU52}, R^{NU61}, and R^{NU62} each independently represent an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, in which one or two or more unadjacent —CH₂— in the group may be independently substituted by —CH═CH—, —C≡C—, —O—, —CO—, —COO—, or —OCO—; but exclude a compound represented by the general formula (S1).)

R^{NU11} is preferably an alkyl group having 1 to 5 carbon atoms or an alkoxy group having 1 to 5 carbon atoms, and more preferably an alkyl group having 2 to 5 carbon atoms.

R^{NU12} is preferably an alkyl group having 1 to 5 carbon atoms or an alkoxy group having 1 to 5 carbon atoms, and more preferably an alkyl group having 2 to 5 carbon atoms.

In addition, R^{NU21}, R^{NU22}, R^{NU31}, R^{NU32}, R^{NU41}, R^{NU42}, R^{NU51}, R^{NU52}, R^{NU61}, and R^{NU62} are each preferably an alkyl group having 1 to 5 carbon atoms or an alkoxy group having 1 to 4 carbon atoms and more preferably an alkyl group having 1 to 5 carbon atoms. However, when a high response speed is regarded as important, R^{NU21}, R^{NU31}, R^{NU41}, R^{NU51}, R^{NU61} are each preferably an alkenyl group having 2 or 3 carbon atoms and particularly preferably an alkenyl group having 2 carbon atoms, and when a large elastic constant (K₃₃) is regarded as important, an alkenyl group having 3 carbon atoms is particularly preferred.

The liquid crystal composition of the present invention preferably contains compounds represented by the general formula (NU-05) and the general formula (NU-01).

The liquid crystal composition of the present invention preferably contains compounds represented by the general formula (NU-05) and the general formula (NU-02).

The liquid crystal composition of the present invention preferably contains compounds represented by the general formula (NU-05) and the general formula (NU-03).

The liquid crystal composition of the present invention preferably contains compounds represented by the general formula (NU-05) and the general formula (NU-04).

The liquid crystal composition of the present invention preferably contains compounds represented by the general formula (NU-05), the general formula (NU-01), and the general formula (NU-02).

The liquid crystal composition of the present invention preferably contains compounds represented by the general formula (NU-05) and the general formula (NU-06).

The liquid crystal composition of the present invention preferably contains compounds represented by the general formula (NU-05), the general formula (NU-06), and the general formula (NU-01).

The liquid crystal composition of the present invention preferably contains compounds represented by the general formula (NU-05), the general formula (NU-06), and the general formula (NU-02).

The liquid crystal composition of the present invention preferably contains compounds represented by the general formula (NU-05), the general formula (NU-06), and the general formula (NU-03).

The liquid crystal composition of the present invention preferably contains compounds represented by the general formula (NU-05), the general formula (NU-06), and the general formula (NU-04).

The liquid crystal composition of the present invention preferably contains compounds represented by the general formula (NU-05), the general formula (NU-06), the general formula (NU-01), and the general formula (NU-02).

The content of the compound represented by the general formula (NU-01) is preferably 0 to 30% by mass, more preferably 0 to 20% by mass, and still more preferably 0 to 10% by mass.

The content of the compound represented by the general formula (NU-02) is preferably 0 to 30% by mass, more preferably 0 to 20% by mass, and still more preferably 0 to 10% by mass.

The content of the compound represented by the general formula (NU-03) is preferably 0 to 20% by mass, more preferably 0 to 15% by mass, and still more preferably 0 to 10% by mass.

The content of the compound represented by the general formula (NU-04) is preferably 0 to 20% by mass, more preferably 0 to 15% by mass, and still more preferably 0 to 10% by mass.

The content of the compound represented by the general formula (NU-05) is preferably 0 to 30% by mass, more preferably 1 to 25% by mass, and still more preferably 2 to 20% by mass.

The content of the compound represented by the general formula (NU-06) is preferably 0 to 20% by mass, more preferably 0 to 15% by mass, and still more preferably 1 to 10% by mass.

The liquid crystal composition of the present invention particularly preferably contains a compound represented by the general formula (NU-05).

The liquid crystal composition of the present invention particularly preferably contains, as the compound represented by the general formula (NU-05), a compound selected from a compound group represented by formula (NU-05-1) to formula (NU-05-10).

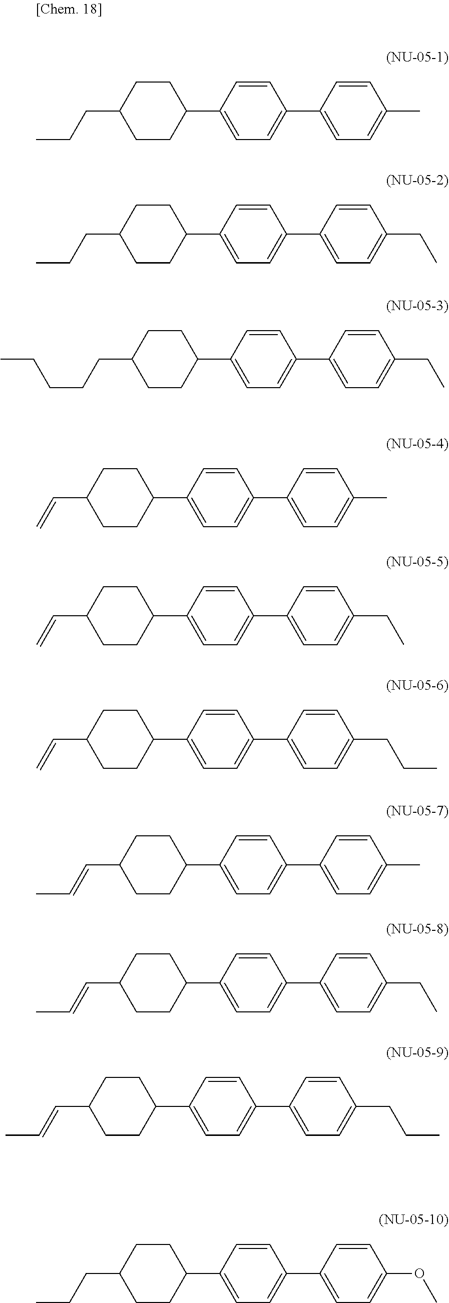

The liquid crystal composition of the present invention preferably contains a compound represented by the formula (NU-05-1).

The liquid crystal composition of the present invention preferably contains a compound represented by the formula (NU-05-2).

The liquid crystal composition of the present invention preferably contains a compound represented by the formula (NU-05-3).

The liquid crystal composition of the present invention preferably contains a compound represented by the formula (NU-05-6).

The liquid crystal composition of the present invention preferably contains a compound represented by the formula (NU-05-9).

The liquid crystal composition of the present invention preferably contains a compound represented by the formula (NU-05-10).

The liquid crystal composition of the present invention preferably contains a compound represented by the formula (NU-05-1) and a compound represented by the formula (NU-05-2).

The liquid crystal composition of the present invention preferably contains a compound represented by the formula (NU-05-2) and a compound represented by the formula (NU-05-3).

The liquid crystal composition of the present invention preferably contains a compound represented by the formula (NU-05-5) and a compound represented by the formula (NU-05-6).

The liquid crystal composition of the present invention preferably contains a compound represented by the formula (NU-05-6) and a compound represented by the formula (NU-05-9).

The liquid crystal composition of the present invention preferably contains a compound represented by the formula (NU-05-1) and compounds represented by the formula (NU-05-2) and the formula (NU-05-3).

The liquid crystal composition of the present invention preferably contains a compound represented by the formula (NU-05-1) and compounds represented by the formula (NU-05-2) and the formula (NU-05-6).

The liquid crystal composition of the present invention preferably contains a compound represented by the formula (NU-05-2) and compounds represented by the formula (NU-05-3) and the formula (NU-05-6).

The liquid crystal composition of the present invention preferably contains a compound represented by the formula (NU-05-1) and compounds represented by the formula (NU-05-6) and the formula (NU-05-9).

The liquid crystal composition of the present invention preferably contains a compound represented by the formula (NU-05-2) and compounds represented by the formula (NU-05-6) and the formula (NU-05-9).

The liquid crystal composition of the present invention preferably contains a compound represented by the general formula (S1), a compound represented by the general formula (S2), and a compound represented by the general formula (S3), further contains one or two or more compounds selected from the compound group represented by the general formula (N-01), the general formula (N-02), the general formula (N-03), and the general formula (N-04), and further contains one or two or more compounds selected from the compound group represented by the general formulae (NU-01) to (NU-06). The upper limit of the total content of these compounds is preferably 100% by mass, 99% by mass, 98% by mass, 97% by mass, 96% by mass, 95% by mass, 94% by mass, 93% by mass, 92% by mass, 91% by mass, or 90% by mass, and the lower limit of the total content is preferably 80% by mass, 82% by mass, 84% by mass, 86% by mass, 88% by mass, 90% by mass, 92% by mass, 94% by mass, 96% by mass, 98% by mass, 99% by mass, or 100% by mass.

The liquid crystal composition of the present invention is a liquid crystal composition having negative dielectric anisotropy (Δε) and containing 10% by mass to 50% by mass of the compound represented by the general formula (S1), 14% by mass to 34% by mass of the compound represented by the general formula (S2), 19% by mass to 39% by mass of the compound represented by the general formula (S3), 10% by mass to 30% by mass of the compound represented by the general formula (N-04-1), and 3% by mass to 30% by mass of the compound represented by the general formula (NU-05), and the total of these components is 85% by mass to 100% by mass.

The liquid crystal composition of the present invention is a liquid crystal composition having negative dielectric anisotropy (Δε) and containing 20% by mass to 45% by mass of the compound represented by the general formula (S1), 15% by mass to 30% by mass of the compound represented by the general formula (S2), 20% by mass to 35% by mass of the compound represented by the general formula (S3), 10% by mass to 20% by mass of the compound represented by the general formula (N-04-1), and 3% by mass to 20% by mass of the compound represented by the general formula (NU-05), and the total of these components is 90% by mass to 100% by mass.

The liquid crystal composition of the present invention may contain one or two or more polymerizable compounds.

The liquid crystal composition of the present invention may contain one or two or more polymerizable compounds represented by general formula (RM),

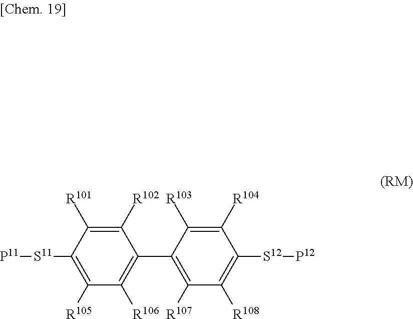

(in the formula, R¹⁰¹, R¹⁰², R¹⁰³, R¹⁰⁴, R¹⁰⁵, R¹⁰⁶, R¹⁰⁷, and R¹⁰⁸ each independently represent P¹³—S¹³—, a hydrogen atom, a fluorine atom, or an alkyl group or alkoxy group having 1 to 18 carbon atoms, which may be substituted by a fluorine atom; P¹¹, P¹², and P¹³ each independently represent a group selected from formula (Re-1) to formula (Re-9)

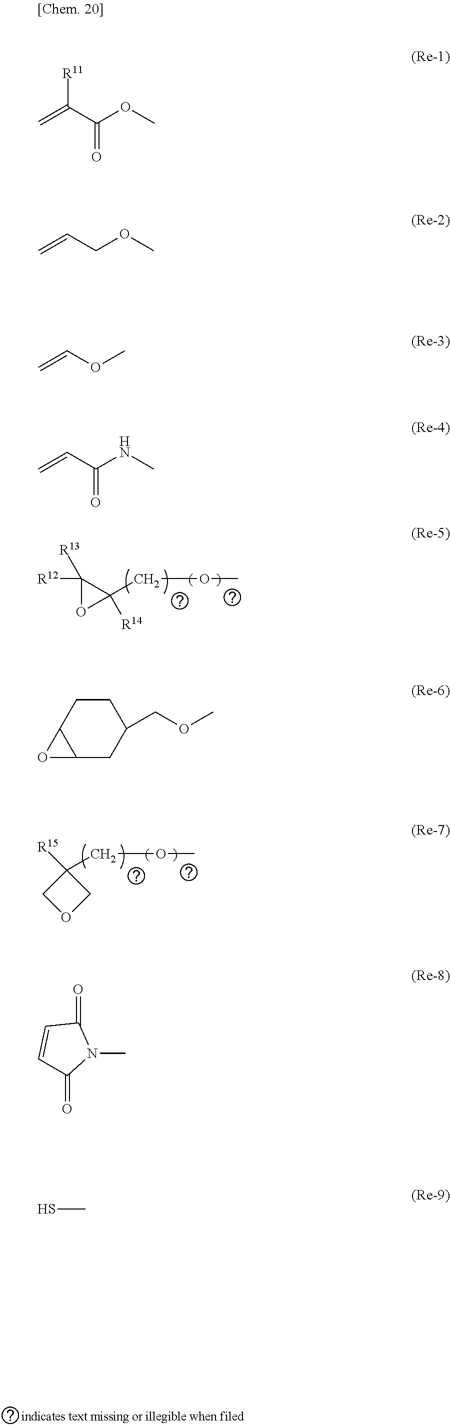

(in the formulae, R¹¹, R¹², R¹³, R¹⁴, and R¹⁵ each independently represent an alkyl group having 1 to 5 carbon atoms, a fluorine atom, or a hydrogen atom, and m^{r5}, m^{r7}, n^{r5}, and n^{r7} each independently represent 0, 1, or 2); S¹¹, S¹², and S¹³ each independently represent a single bond or an alkylene group having 1 to 15 carbon atoms, in which one —CH₂— or two or more unadjacent —CH₂— in the alkylene group may be independently substituted by —O—, —OCO—, or —COO— so that oxygen atoms are not directly adjacent to each other; and when there are a plurality of P¹³ and S¹³, they may be the same or different).

The liquid crystal composition containing the polymerizable compound represented by the general formula (RM) is suitable for producing a PSA-mode or PSVA-mode liquid crystal display device. Also, the liquid crystal composition is suitable for producing a NPS-mode or PI-less-mode liquid crystal display device.

In the general formula (RM), R¹⁰¹, R¹⁰², R¹⁰³, R¹⁰⁴, R¹⁰⁵, R¹⁰⁶, R¹⁰⁷, and R¹⁰⁸ each independently represent P¹³—S¹³—, an alkyl group having 1 to 18 carbon atoms, which may be substituted by a fluorine atom, an alkoxy group having 1 to 18 carbon atoms, which may be substituted by a fluorine atom, a fluorine atom, or a hydrogen atom. In the case of an alkyl group or alkoxy group, the number of carbon atoms is preferably 1 to 16, more preferably 1 to 10, still more preferably 1 to 4, and particularly preferably 1. The alkyl group and alkoxy group may be linear or branched and are preferably linear.

In the general formula (RM), R¹⁰¹, R¹⁰², R¹⁰³, R¹⁰⁴, R¹⁰⁵, R¹⁰⁶, R¹⁰⁷, and R¹⁰⁸ preferably each independently represent P¹³—S¹³—, an alkoxy group having 1 to 3 carbon atoms, which may be substituted by a fluorine atom, a fluorine atom, or a hydrogen atom, and more preferably each represent P¹³—S¹³—, an alkoxy group having 1 to 3 carbon atoms, a fluorine atom, or a hydrogen atom. The alkoxy group preferably has 1 or more and 3 or less carbon atoms, more preferably has 1 or more and 2 or less carbon atoms, and particularly preferably has 1 carbon atom.

In the general formula (RM), P¹¹, P¹², and P¹³ are preferably each the formula (Re-1), the formula (Re-2), the formula (Re-3), or the formula (Re-4), more preferably each the formula (Re-1), still more preferably each an acryl group or a methacryl group, and particularly preferably each a methacryl group.

In the general formula (RM), P¹¹, P¹², and P¹³ may all be the same polymerizable group or different polymerizable groups. At least one of P¹¹ and P¹² is preferably the formula (Re-1), more preferably an acryl group or methacryl group, and still more preferably a methacryl group, and P¹¹ and P¹² are particularly preferably methacryl groups.

In the general formula (RM), S¹¹, S¹², and S¹³ are preferably each independently a single bond or an alkylene group having 1 to 5 carbon atoms and particularly preferably each independently a single bond. When S¹¹, S¹², and S¹³ are each a single bond, the amount of the polymerizable compound remaining after ultraviolet irradiation is sufficiently decreased, thereby causing little occurrence of a display defect due to a change in the pretilt angle and causing no or very few display defects in the PSA-mode or PSVA-mode liquid crystal display device. When S¹¹, S¹², and S¹³ each have 1 to 3 carbon atoms, it is suitable for the NPS-mode liquid crystal display device.

The lower limit of the content of the polymerizable compound represented by the general formula (RM) in the liquid crystal composition of the present invention is preferably 0.01% by mass, preferably 0.02% by mass, preferably 0.03% by mass, preferably 0.04% by mass, preferably 0.05% by mass, preferably 0.06% by mass, preferably 0.07% by mass, preferably 0.08% by mass, preferably 0.09% by mass, preferably 0.1% by mass, preferably 0.12% by mass, preferably 0.15% by mass, preferably 0.17% by mass, preferably 0.2% by mass, preferably 0.22% by mass, preferably 0.25% by mass, preferably 0.27% by mass, preferably 0.3% by mass, preferably 0.32% by mass, preferably 0.35% by mass, preferably 0.37% by mass, preferably 0.4% by mass, preferably 0.42% by mass, preferably 0.45% by mass, preferably 0.5% by mass, and preferably 0.55% by mass. The upper limit of the content of the polymerizable compound represented by the general formula (RM) in the liquid crystal composition of the present invention is preferably 5% by mass, preferably 4.5% by mass, preferably 4% by mass, preferably 3.5% by mass, preferably 3% by mass, preferably 2.5% by mass, preferably 2% by mass, preferably 1.5% by mass, preferably 1% by mass, preferably 0.95% by mass, preferably 0.9% by mass, preferably 0.85% by mass, preferably 0.8% by mass, preferably 0.75% by mass, preferably 0.7% by mass, preferably 0.65% by mass, preferably 0.6% by mass, preferably 0.55% by mass, preferably 0.5% by mass, preferably 0.45% by mass, and preferably 0.4% by mass.

In further detail description, in order to achieve the satisfactory pretilt angle, the small amount of polymerizable compound remaining, or the high voltage holding ratio (VHR), the content thereof is preferably 0.2% to 0.6% by mass. When it is considered important to suppress precipitation at a low temperature, the content is preferably 0.01% to 0.4% by mass. In order to achieve the particularly high response speed, it is also preferred to increase the content to 2% by mass.

In addition, when the liquid crystal composition contains a plurality of polymerizable compounds represented by the general formula (RM), the content is preferably 0.01% to 0.4% by mass. Therefore, in order to solve all problems, the content of the polymerizable compound represented by the general formula (RM) is preferably adjusted within a range of 0.1% to 0.6% by mass.

Preferred examples of the polymerizable compound represented by the general formula (RM) according to the present invention include compounds represented by general formulae (RM-1) to (RM-10).

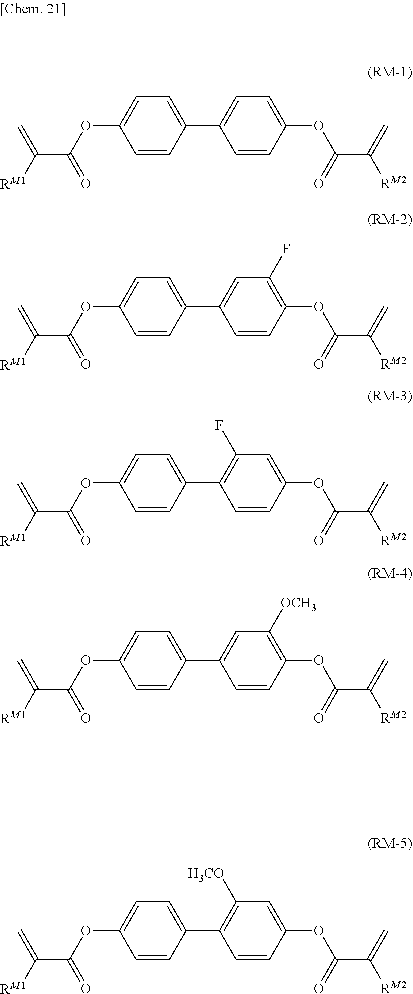

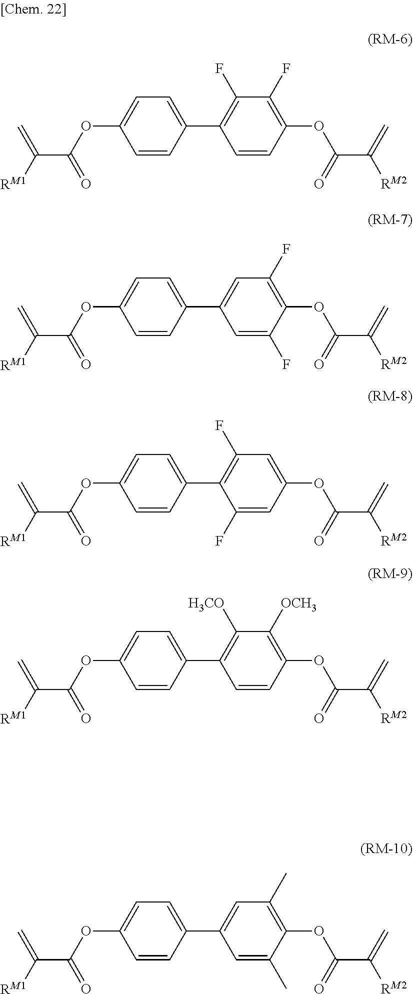

(In the formulae, R^{M1} and R^{M2} each independently represent an alkyl group having 1 to 3 carbon atoms, a fluorine atom, or a hydrogen atom, but more preferably represent an alkyl group having 1 carbon atom or a hydrogen atom.) A PSA-mode liquid crystal display device using any one of these compounds exhibits a small amount of polymerizable compound remaining and has a satisfactory pretilt angle and no or very few defects such as alignment defect and display defect due to a change in the pretilt angle or the like.

The liquid crystal composition according to the present invention can contain one or two or more compounds having a terphenyl structure or a tetraphenyl structure and a dielectric anisotropy Δε of more than +2, that is, one or two or more compounds having positive dielectric anisotropy. The Δε of a compound is a value extrapolated from the measured value of the dielectric anisotropy of a composition prepared by adding the compound to a composition substantially dielectrically neutral at 25° C. The compounds are used in combination according to the desired performances such as, for example, low-temperature solubility, transition temperature, electric reliability, refractive index anisotropy, etc. In particular, the reactivity of the polymerizable compound in the liquid crystal composition containing the polymerizable compound can be increased.

The lower limit value of the preferred content of the compound having a terphenyl structure or a tetraphenyl structure and a dielectric anisotropy Δε more than +2 relative to the total amount of the liquid crystal composition of the present invention is 0.1%, 0.5%, 1%, 1.5%, 2%, 2.5%, 3%, 4%, 5%, or 10%. For example, in an aspect of the present invention, the upper limit value of the preferred content relative to the total amount of the liquid crystal composition of the present invention is 20%, 15%, 10%, 9%, 8%, 7%, 6%, 5%, 4%, or 3%.

Preferred examples of the compound which can be used in the liquid crystal composition of the present invention and which has a terphenyl structure or a tetraphenyl structure and a dielectric anisotropy of more than +2 include compounds represented by formula (M-8.51) to formula (M-8.54), compounds represented by formula (M-7.1) to formula (M-7.4), compounds represented by formula (M-7.11) to formula (M-7.14), and compounds represented by formula (M-7.21) to formula (M-7.24).

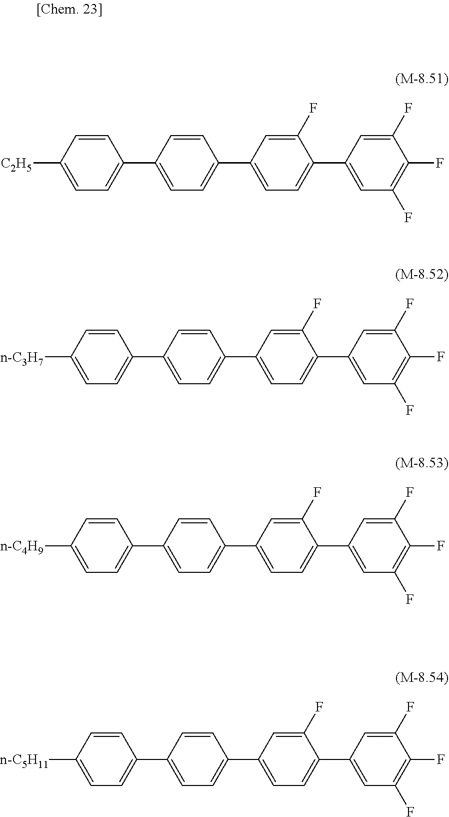

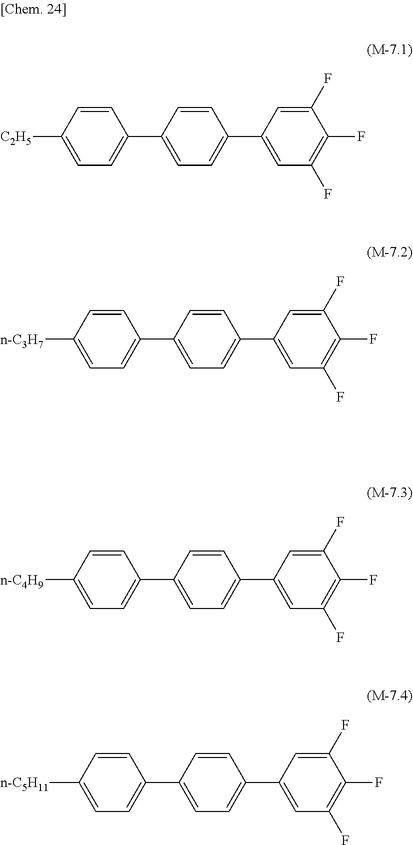

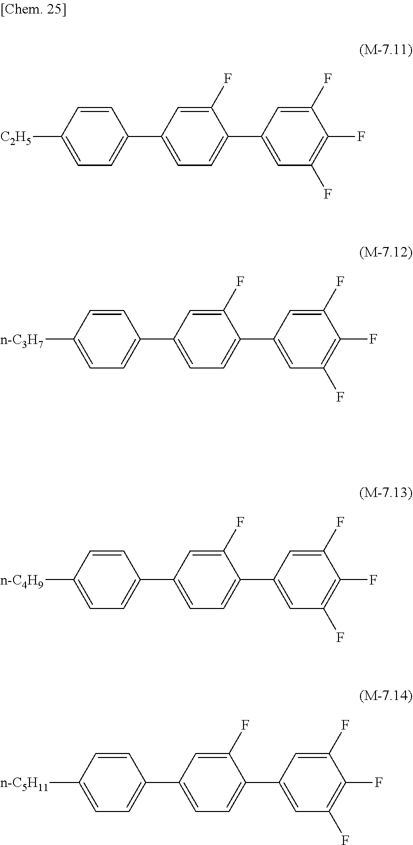

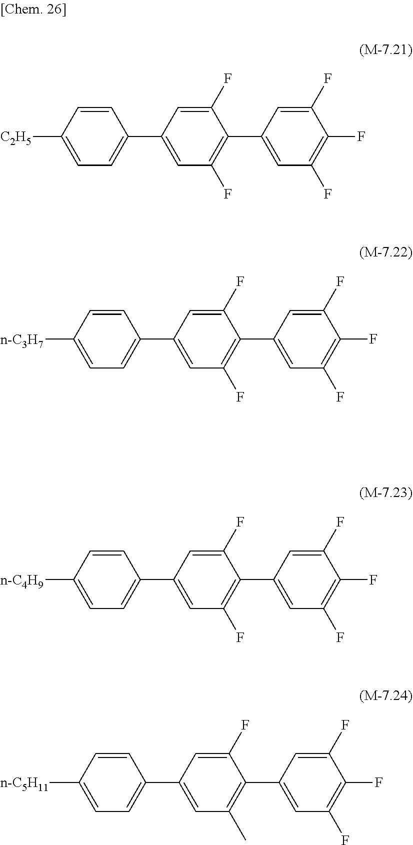

In order to increase Tₙᵢ of the liquid crystal composition of the present invention, the liquid crystal composition may contain any one of compounds of formula (L-7.1) to formula (L-7.4), formula (L-7.11) to formula (L-7.13), formula (L-7.21) to formula (L-7.23), formula (L-7.31) to formula (L-7.34), formula (L-7.41) to formula (L-7.44), and formula (L-7.51) to formula (L-7.53), which have four rings and substantially zero dielectric value (generally within a range of −2 to +2).

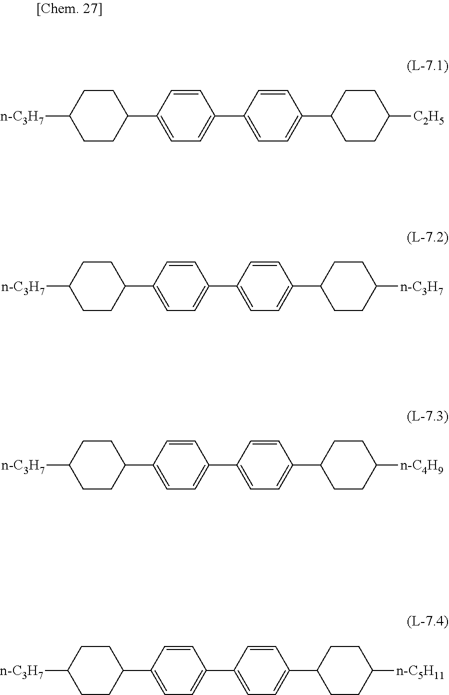

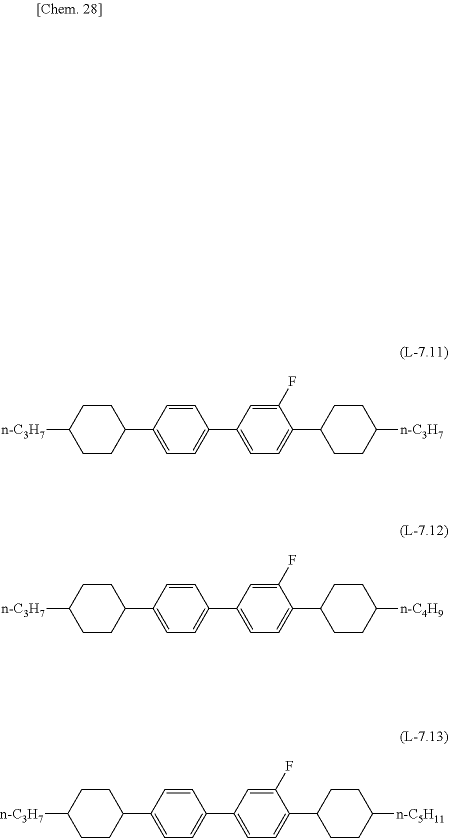

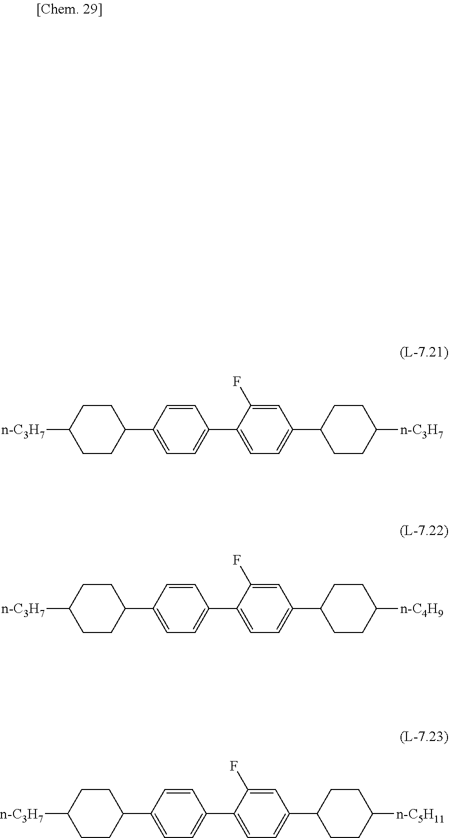

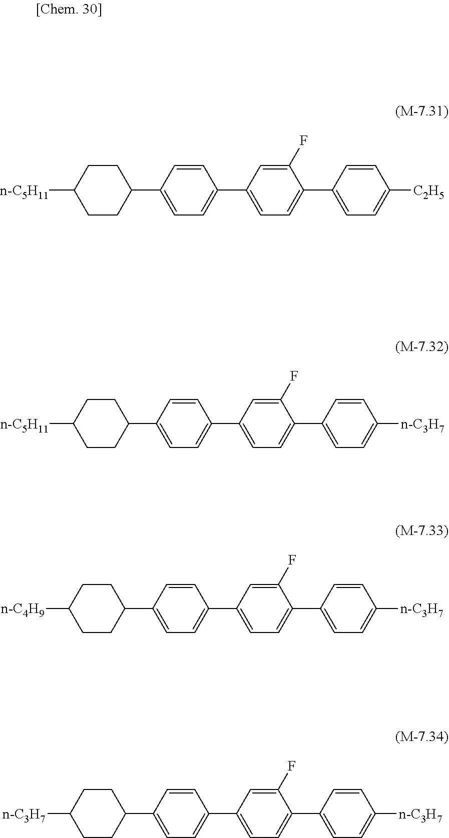

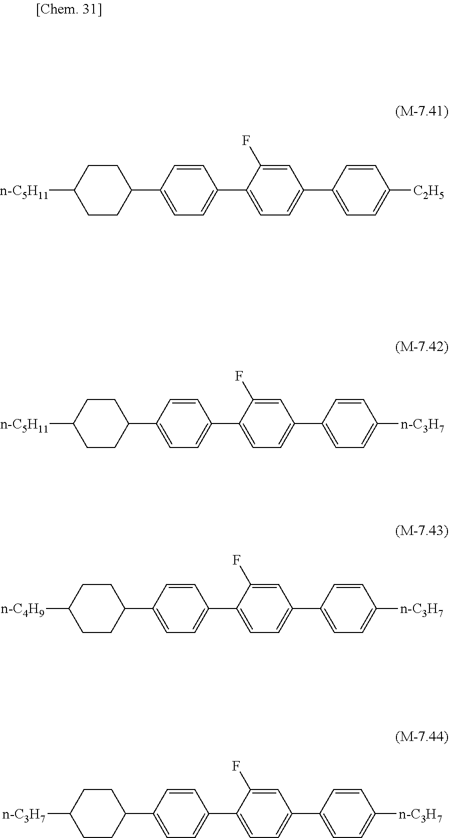

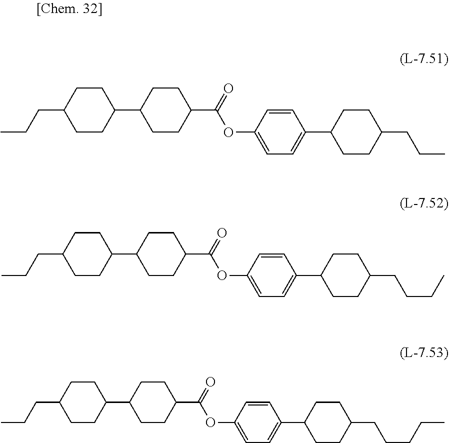

Besides the compounds described above, the liquid crystal composition of the present invention may contain a general nematic liquid crystal, smectic liquid crystal, cholesteric liquid crystal, antioxidant, ultraviolet absorber, light stabilizer, infrared absorber, or the like.

Examples of the antioxidant include hindered phenols represented by general formula (H-1) to general formula (H-4).

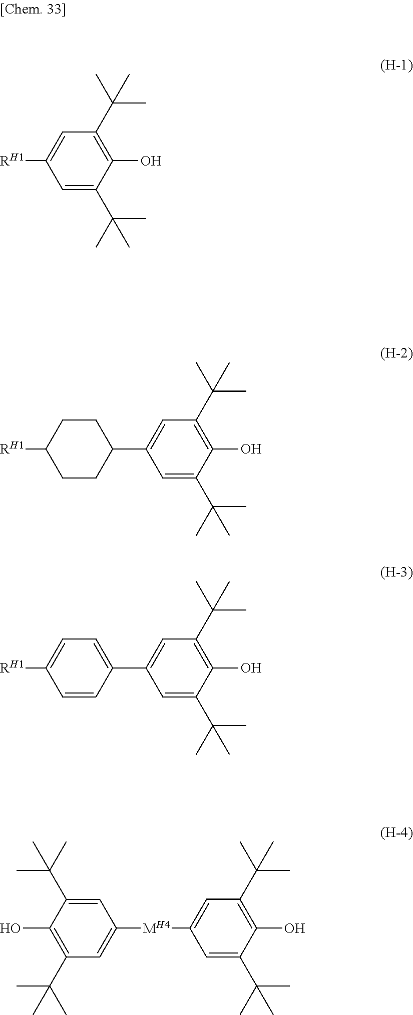

In the general formula (H-1) to the general formula (H-3), R^{H1} each independently represent an alkyl group having 1 to 10 carbon atoms, an alkoxy group having 1 to 10 carbon atoms, an alkenyl group having 2 to 10 carbon atoms, or an alkenyloxy group having 2 to 10 carbon atoms, wherein one —CH₂— or two or more unadjacent —CH₂— present in the group may be each independently substituted by —O— or —S—, and one or two or more hydrogen atoms present in the group may be each independently substituted by a fluorine atom or a chlorine atom. More specifically, R^{H1} is preferably an alkyl group having 2 to 7 carbon atoms, an alkoxy group having 2 to 7 carbon atoms, an alkenyl group having 2 to 7 carbon atoms, or an alkenyloxy group having 2 to 7 carbon atoms, and more preferably an alkyl group having 3 to 7 carbon atoms or an alkenyl group having 2 to 7 carbon atoms.

In the general formula (H-4), M^{R4} represents a single bond, an alkylene group having 1 to 10 carbon atoms, a 1,4-phenylene group (any one of hydrogen atoms in the group may be substituted by a fluorine atom), or a trans-1,4-cyclohexylene group.

In the general formula (H-1) to the general formula (H-4), one or two or more unadjacent —CH═ in the 1,4-phenylene group may be substituted by —N═. Also, hydrogen atoms in the 1,4-phenylene group may be each independently substituted by a fluorine atom or a chlorine atom.

In the general formula (H-2) and the general formula (H-4), one or two or more unadjacent —CH₂— in the 1,4-cyclohexylene group may be substituted by —O— or —S—. Also, hydrogen atoms in the 1,4-cyclohexylene group may be each independently substituted by a fluorine atom or a chlorine atom.

Specific examples thereof include formula (H-11) to formula (H-15).

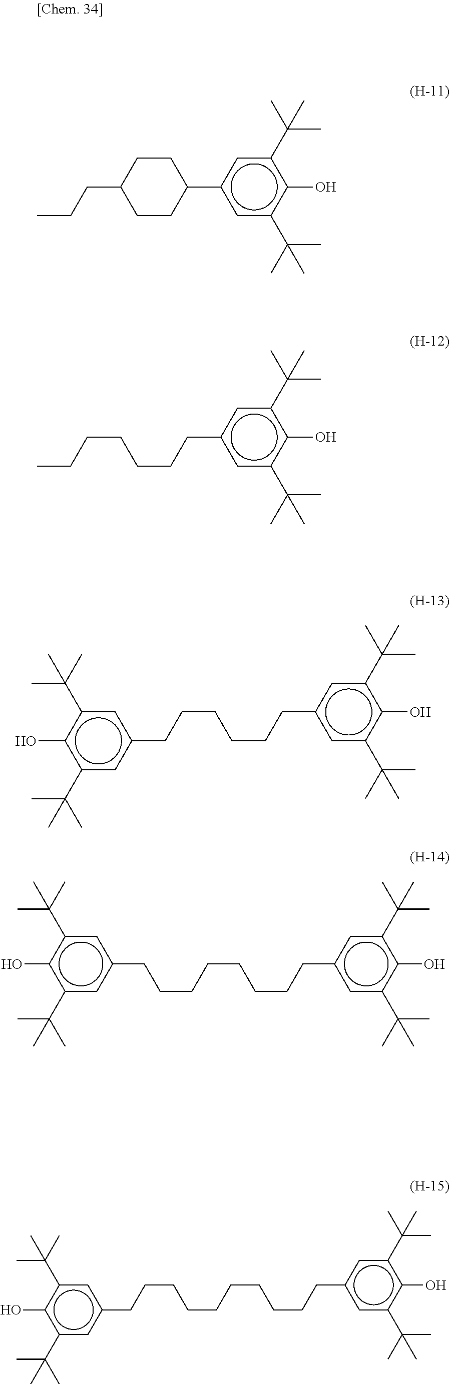

When the liquid crystal composition of the present invention contains the antioxidant, the lower limit of the content is 5 ppm by mass, preferably 10 ppm by mass, preferably 20 ppm by mass, or preferably 50 ppm by mass. The upper limit of the content is 2000 ppm by mass, and preferably 1000 ppm by mass, preferably 500 ppm by mass, or 100 ppm by mass.

When the liquid crystal composition of the present invention contains a light stabilizer, hindered amine-based Tinuvin 770 (manufactured by BASF) or LA-57 (manufactured by ADEKA) may be used. The lower limit of the content thereof is preferably 50 ppm by mass or more, preferably 100 ppm by mass or more, or preferably 200 ppm by mass or more. The upper limit of the content is 2000 ppm by mass, but is preferably 1000 ppm by mass, or preferably 500 ppm by mass.

The nematic phase-isotropic liquid phase transition temperature (Tm) of the liquid crystal composition of the present invention is 60° C. to 120° C., preferably 70° C. to 100° C., and particularly preferably 75° C. to 90° C. In the case of application to a liquid crystal television, T_{NI} is preferably 70° C. to 80° C.; in the case of mobile application, T_{NI} is preferably 75° C. to 90° C.; and in the case of vehicle-mounted application, PID (Public Information Display), or the like, T_{NI} is preferably 90° C. to 110° C.

The refractive index anisotropy (Δn) at 20° C. of the liquid crystal composition of the present invention is 0.08 to 0.14, more preferably 0.09 to 0.13, and particularly preferably 0.09 to 0.12. In further detail, in a case corresponding to a thin cell gap, the refractive index anisotropy is preferably 0.10 to 0.13, while in a case corresponding to a thick cell gap, the refractive index anisotropy is preferably 0.08 to 0.10.

The rotational viscosity (γ₁) at 20° C. of the liquid crystal composition of the present invention is 50 to 160 mPa·s, preferably 55 to 160 mPa·s, preferably 60 to 160 mPa·s, preferably 80 to 150 mPa·s, preferably 90 to 140 mPa·s, preferably 90 to 130 mPa·s, or preferably 90 to 120 mPa·s.

The dielectric anisotropy (Δε) at 20° C. of the liquid crystal composition of the present invention is −2.0 to −8.0, preferably −2.0 to −6.0, more preferably −2.0 to −5.0, still more preferably −2.5 to −4.0, and particularly preferably −2.5 to −3.5.

The liquid crystal display device using the liquid crystal composition of the present invention is useful particularly for a liquid crystal display device for active matrix driving, and can be properly used for a liquid crystal display of VA, FFS, IPS, PSA, PSVA, PS-IPS, or PS-FFS, NPS, PI-less, or the like.

The liquid crystal display device according to the present invention preferably includes a first substrate and a second substrate which are disposed opposite to each other, a common electrode provided on the first substrate or the second substrate, a pixel electrode provided on the first substrate or the second substrate and having a thin-film transistor, and a liquid crystal layer which contains a liquid crystal composition and which is provided between the first substrate and the second substrate. If required, an alignment film which controls the alignment direction of liquid crystal molecules may be provided on the facing surface side of at least one of the first substrate and/or the second substrate so as to be in contact with the liquid crystal layer. The alignment film can be properly selected from a vertical alignment film and a horizontal alignment film in accordance with the drive mode of the liquid crystal display device, and a known alignment film such as a rubbing alignment film (for example, polyimide), an optical alignment film (decomposable polyimide or the like), or the like can be used. Further, a color filter may be properly provided on the first substrate or the second substrate, and a color filter can be provided on the pixel electrode or the common electrode.

A transparent material with flexibility, such as glass or plastic, can be used for two substrates of a liquid crystal cell used in the liquid crystal display device according to the present invention, and one of the substrates may be made of an opaque material such as silicon or the like. A transparent substrate having a transparent electrode layer can be produced by, for example, sputtering indium tin oxide (ITO) on the transparent substrate such as a glass plate or the like.

The color filter can be formed by, for example, a pigment dispersion method, a printing method, an electrodeposition method, a dyeing method, or the like. An example of a method for forming the color filter by the pigment dispersion method is described. A curable color composition for a color filter is applied on the transparent substrate, patterned, and then cured by heating or light irradiation. These steps are performed for each of the three colors of red, green, and blue, whereby pixel portions for the color filter can be formed. In addition, a pixel electrode provided with an active element such as TFT, a thin-film diode, a metal-insulator-metal resistivity element, or the like may be provided on the substrate.

The first substrate and the second substrate are preferably opposed to each other so that the common electrode and the pixel element layer are disposed on the inside.

The gap between the first substrate and the second substrate may be adjusted through a spacer. In this case, the gap is preferably adjusted so that the thickness of the resultant light control layer is 1 to 100 μm. The thickness is more preferably 1.5 to 10 μm, and when a polarizing plate is used, the product of the refractive index anisotropy Δn of liquid crystal and the cell thickness d is preferably adjusted to maximize the contrast. Also, when two polarizing plates are present, the polarization axis of each of the polarizing plates can be adjusted to improve the viewing angle and contrast. Further, a retardation film can be used for widening the viewing angle. Examples of the spacer include glass particles, plastic particles, alumina particles, a photoresist material, and the like. Then, a seal agent such as an epoxy-based thermosetting composition or the like is screen-printed on each of the substrates provided with a liquid crystal injection port, the substrates are bonded together, and then the seal agent is thermally cured by heating.

A method for holding the liquid crystal composition between the two substrates can use a general vacuum injection method or ODF method, or the like.

In order to form an alignment state in the liquid crystal display device of the present invention, a liquid crystal composition containing a polymerizable compound is used, and the alignment state can be formed by polymerizing the polymerizable compound in the liquid crystal composition.

In order to achieve the good alignment performance in liquid crystal layer, polymerization at a proper polymerization rate is desired. Therefore, a method of polymerizing the polymerizable compound contained in the liquid crystal composition of the present invention is preferably a method of polymerization by irradiation with one or combination of two or more of ultraviolet light and active energy rays such as electron beams and the like or by sequential irradiation with these rays. When ultraviolet light is used, a polarized light source or an unpolarized light source may be used. When the liquid crystal composition is polymerized in the state of being held between the two substrates, at least the irradiation-side substrate is required to be imparted with proper transparency to active energy rays. Another method may also be used, in which only a specified portion is polymerized using a mask during light irradiation, and then the alignment state of an unpolymerized portion is changed by changing the condition such as an electric field, a magnetic field, or a temperature, or the like, followed by further polymerization by irradiation with active energy rays. In particular, in the case of ultraviolet exposure, the ultraviolet exposure is preferably performed with the alternating-current electric field applied to the liquid crystal composition. The alternating-current electric field applied is preferably of alternating current at a frequency of 10 Hz to 10 kHz and more preferably a frequency of 60 Hz to 10 kHz, and the voltage is selected depending on the desired pretilt angle of the liquid crystal display device. That is, the pretilt angle of the liquid crystal display device can be controlled by the voltage applied. In a PSVA-mode liquid crystal display device, the pretilt angle is preferably controlled to 80° to 89.9° from the viewpoint of alignment stability and contrast.

When the polymerizable compound contained in the liquid crystal composition of the present invention is polymerized by irradiation with ultraviolet light or active energy rays, such as electron beams or the like, the temperature is not particularly limited. For example, when the liquid crystal composition of the present invention is applied to a liquid crystal display device provided with a substrate having an alignment film, the temperature is preferably within a range in which the liquid crystal state of the liquid crystal composition is maintained. Polymerization is preferably performed at a temperature close to room temperature or typically at 15° C. to 35° C.

On the other hand, for example, when the liquid crystal composition of the present invention is applied to a liquid crystal display device provided with a substrate without an alignment film, the temperature range of irradiation may be wider than that applied to the liquid crystal display device provided with a substrate having an alignment film.

Usable examples of a lamp which generates ultraviolet light include a metal halide lamp, a high-pressure mercury lamp, an ultra-high-pressure mercury lamp, and the like. The irradiating ultraviolet light is preferably ultraviolet light at a wavelength within a wavelength region which is not the absorption wavelength region of the liquid crystal composition. If required, ultraviolet light is preferably cut and used. The intensity of the irradiating ultraviolet light is preferably 0.1 mW/cm² to 100 W/cm² and more preferably 2 mW/cm² to 50 W/cm². The energy amount of the irradiating ultraviolet light can be properly adjusted, but is preferably 10 mJ/cm² to 500 J/cm² and more preferably 100 mJ/cm² to 200 J/cm². The intensity may be changed during ultraviolet irradiation. The time of ultraviolet irradiation is properly selected according to the intensity of irradiating ultraviolet light, but is preferably 10 seconds to 3600 seconds and more preferably 10 seconds to 600 seconds.

### EXAMPLES

The present invention is described in further detail below by giving examples, but the present invention is not limited to these examples. In a composition of each of examples and comparative examples, “%” represents “% by mass”. In the examples, compounds are described by using the following abbreviations.

(Side Chain)

-n —CₙH₂ₙ₊₁ a linear alkyl group having n carbon atoms

n- CH₂ₙ₊₁— a linear alkyl group having n carbon atoms

—On —OCₙH₂ₙ₊₁ a linear alkoxy group having n carbon atoms

nO— CₙH₂ₙ₊₁O— a linear alkoxy group having n carbon atoms

—V —CH═CH₂

V— CH₂═CH—

—V— —CH═CH—

—V1 —CH═CH—CH₃

1V— CH₃—CH═CH—

—F —F

—OCF3 —OCF₃

(Linking Group)

—CF2O— —CF₂—O—

—OCF2- —O—CF₂—

-1O— —CH₂—O—

—O1- —O—CH₂—

-2- —CH₂—CH₂—

—COO— —COO—

- single bond

—OCO— —OCO—

(Ring Structure)

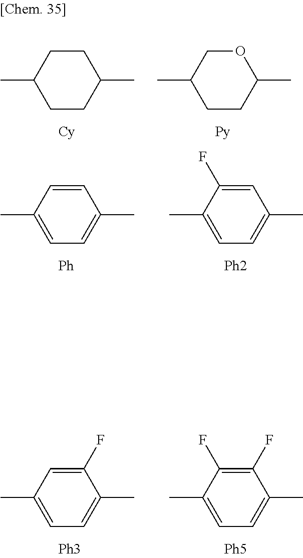

In the examples, the measured characteristics are as follows.

T_{NI}=: nematic phase-isotopic liquid phase transition temperature (° C.)

T_{CN}: solid phase-nematic phase transition temperature

Δn: refractive index anisotropy at 20° C.

Δε: dielectric anisotropy at 20° C.

γ₂: rotational viscosity at 20° C. (mPa·s)

K₁₁: elastic constant K₁₁ at 20° C. (pN)

K₃₃: elastic constant K₃₃ at 20° C. (pN)

γ₁/K₃₃: a lower value showing a higher response speed

VHR: voltage holding ratio (%) at 1 V, 60 Hz, and 60° C., measured after UV irradiation with 12 J of the liquid crystal display device

Low temperature storage stability (LTS): A liquid crystal display device was stored at −30° C. for 240 hours, and then the presence of display defects such as bright spots and the like were confirmed. No display defect was denoted as “OK”, and the presence of display defects was denoted as “NG”.

(Preparation and Evaluation Results of Liquid Crystal Composition)

Liquid crystal compositions of Examples 1 (LC-1), Comparative Example 1 (LC-A), and Comparative Example 2 (LC-B) were prepared and the physical property values thereof were measured. The component ratios and the results of physical property values of the liquid crystal compositions are as shown in Table 1.

TABLE 1

| | General | Example 1 | Comparative |
|---|---|---|---|
| Molecular structure | Formula | LC-1 | Example 1 LC-A |
| 3-Cy-Cy-V | S1 | 37 | 37 |
| 3-Cy-Ph5-O2 | S2 | 10 | — |
| 5-Cy-Ph5-O2 | S2 | 5 | — |
| 2-Cy-Cy-1O-Ph5-O2 | S3 | 12 | 12 |
| 3-Cy-Cy-1O-Ph5-O2 | S3 | 12 | 12 |
| 2-Ph-2-Ph-Ph5-O2 | N-04-1 | 6 | — |
| 3-Ph-2-Ph-Ph5-O2 | N-04-1 | 6 | — |
| 3-Cy-Ph-Ph-2 | NU-05 | 6 | 6 |
| V-Cy-Ph-Ph-3 | NU-05 | 6 | 6 |
| 3-Cy-1O-Ph5-O1 | — | — | 10 |
| 3-Cy-1O-Ph5-O2 | — | — | 5 |
| 2-Cy-Ph-Ph5-O2 | N-03 | — | 6 |
| 3-Cy-Ph-Ph5-O2 | N-03 | — | 6 |
| Total [%] | | 100 | 100 |
| T_{NI} [° C.] | | 78 | 83 |
| T_{CN} [° C.] | | −59 | −50 |
| Δn | | 0.099 | 0.096 |
| Δε | | −3.2 | −3.6 |
| γ₁ [mPa•s] | | 102 | 117 |
| K₁₁ [pN] | | 14.8 | 14.7 |
| K₃₃ [pN] | | 15.7 | 15.5 |
| γ₁/K₃₃ | | 6.5 | 7.5 |
| VHR [%] | | 97 | 81 |
| LTS | | OK | NG |

Example 1 (LC-1) showed high T_{NI} and low T_{CN}, and thus had a wide nematic phase transition temperature range, and also had large Δn, negative Δε and a large absolute value thereof, small γ₇, large K₁₁, large K₃₃, and small γ₁/K₃₃ correlated with the response speed. In addition, FFS-mode and VA-mode liquid crystal display devices produced by using the liquid crystal composition of this example simultaneously satisfied the high response speed, high VHR, and excellent low-temperature storage stability, and no occurrence of display defects was confirmed. That is, the liquid crystal composition of Example 1 (LC-1) has excellent physical properties and can solve the problem of the present invention.

In contrast, it was confirmed that FFS-mode and VA-mode liquid crystal display devices produced by using Comparative Example 1 (LC-A) has a remarkably low response speed which is a response speed lower by about 15% than that of Example 1 (LC-1). In addition, Comparative Example (LC-A) exhibited a VHR value of as very low as 81, and display defects were confirmed. Further, the LTS result of Comparative Example 1 was “NG”. Therefore, it was confirmed that Comparative Example 1 (LC-A) cannot solve the problem of the present invention.

Liquid crystal compositions of Example 2 (LC-2), Example 3 (LC-3), Comparative Example 2 (LC-B), and Example 4 (LC-4) were prepared and the physical property values thereof were measured. The component ratios and physical property values of the liquid crystal compositions are as shown in Table 2.

TABLE 2

| | | | | Comparative | |
|---|---|---|---|---|---|
| | General | Example 2 | Example 3 | Example 2 | Example 4 |
| Molecular structure | formula | LC-2 | LC-3 | LC-B | LC-4 |
| 3-Cy-Cy-V | S1 | 28 | 28 | 37 | 28 |
| 3-Cy-Ph5-O2 | S2 | 10 | 10 | — | 14 |
| 5-Cy-Ph5-O2 | S2 | 5 | 5 | — | — |
| 2-Cy-Cy-1O-Ph5-O2 | S3 | 12 | 12 | 12 | 12 |
| 3-Cy-Cy-1O-Ph5-O2 | S3 | 12 | 12 | 12 | 12 |
| 1V-Cy-Cy-1O-Ph5-O2 | S3 | — | — | — | 3 |
| 2-Ph-2-Ph-Ph5-O2 | N-04-1 | 6 | 6 | 6 | 6 |
| 3-Ph-2-Ph-Ph5-O2 | N-04-1 | 6 | 6 | 6 | 6 |
| 3-Cy-Ph-Ph-2 | NU-05 | 6 | 6 | 6 | 3 |
| 5-Cy-Ph-Ph-2 | NU-05 | — | — | — | 3 |
| V-Cy-Ph-Ph-3 | NU-05 | 6 | 6 | 6 | 6 |
| 3-Cy-Cy-2 | NU-01 | — | 9 | — | — |
| 3-Cy-Ph-O1 | NU-02 | 9 | — | — | 2 |
| 3-Ph-Ph-1 | NU-03 | — | — | — | 5 |
| 3-Ph-Ph5-O2 | N-02 | — | — | 15 | — |
| Total [%] | | 100 | 100 | 100 | 100 |
| T_{NI} [° C.] | | 74 | 77 | 76 | 76 |
| T_{CN} [° C.] | | −55 | −34 | −23 | −56 |
| Δn | | 0.102 | 0.097 | 0.111 | 0.110 |
| Δε | | −3.3 | −3.1 | −3.1 | −3.2 |
| γ₁ [mPa•s] | | 103 | 100 | 100 | 109 |
| K₁₁ [pN] | | 13.9 | 14.8 | 14.8 | 14.8 |
| K₃₃ [pN] | | 15.0 | 14.8 | 15.1 | 15.3 |
| γ₁/K₃₃ | | 6.9 | 6.8 | 6.6 | 7.1 |
| VHR [%] | | 98 | 98 | 98 | 98 |
| LTS | | OK | OK | NG | OK |

Example 2 (LC-2), Example 3 (LC-3), and Example 4 (LC-4) showed high T_{NI} and low T_{CN}, and thus had a wide nematic phase transition temperature range, and also had large Δn, negative large Δε, small γ₁, large K₃₃, and small γ₁/K₃₃ correlated with the response speed a liquid crystal display device. In addition, FFS-mode liquid crystal display devices produced by using the liquid crystal compositions of these examples simultaneously satisfied the high response speed, high VHR, and excellent low-temperature storage stability, and no occurrence of display defects was confirmed.

In contrast, Comparative Example 2 (LC-B) exhibited high T_{CN} and LTS result “NG”, and bright spots were confirmed as an alignment defect. Therefore, it was confirmed that the problem of the present invention cannot be solved, and this example is unsuitable for a cellular phone, a smartphone, notebook PC, tablet PC, vehicle-mounted LCD, and the like, which are estimated to be used outdoors.

Liquid crystal compositions of Example 5 (LC-5), Example 6 (LC-6), and Example 7 (LC-7) were prepared and the physical property values thereof were measured. The component ratios and physical property values of the liquid crystal compositions are as shown in Table 3.

TABLE 3

| | General | Example 5 | Example 6 | Example 7 |
|---|---|---|---|---|
| Molecular structure | Formula | LC-5 | LC-6 | LC-7 |
| 3-Cy-Cy-V | S1 | 30 | 37 | 26 |
| 3-Cy-Ph5-O1 | S2 | 5 | — | — |
| 3-Cy-Ph5-O2 | S2 | 15 | 15 | 14 |
| 3-Cy-Ph5-O4 | S2 | 6 | — | — |
| 3-Cy-Cy-1O-Ph5-O2 | S3 | 15 | 4 | — |
| V-Cy-Cy-1O-Ph5-O2 | S3 | — | 7 | 7 |
| V-Cy-Cy-1O-Ph5-O3 | S3 | — | 7 | 7 |
| 1V-Cy-Cy-1O-Ph5-O2 | S3 | 5 | — | 7 |
| 1-Ph-2-Ph-Ph5-O2 | N-04-1 | — | 4 | — |
| 2-Ph-2-Ph-Ph5-O2 | N-04-1 | 6 | 4 | 6 |
| 3-Ph-2-Ph-Ph5-O2 | N-04-1 | 6 | 4 | 6 |
| 3-Cy-Ph-Ph-2 | NU-05 | 4 | 4 | 6 |
| 1V-Cy-Ph-Ph-3 | NU-05 | — | 4 | — |
| V-Cy-Ph-Ph-3 | NU-05 | 4 | 4 | 8 |
| 3-Ph-Ph-1 | NU-03 | — | — | 6 |
| 3-Cy-Cy-Ph-1 | NU-04 | 2 | 6 | 7 |
| 3-Cy-Cy-Ph5-O2 | N-01 | 2 | — | — |
| Total [%] | | 100 | 100 | 100 |
| T_{NI} [° C.] | | 71 | 78 | 81 |
| T_{CN} [° C.] | | −55 | −54 | −54 |
| Δn | | 0.098 | 0.100 | 0.112 |
| Δε | | −3.6 | −2.5 | −2.7 |
| γ₁ [mPa•s] | | 115 | 92 | 108 |
| K₁₁ [pN] | | 13.6 | 14.1 | 15.6 |
| K₃₃ [pN] | | 15.2 | 15.4 | 16.8 |
| γ₁/K₃₃ | | 7.6 | 6.0 | 6.4 |
| VHR [%] | | 98 | 98 | 98 |
| LTS | | OK | OK | OK |

It was confirmed that Example 5 (LC-5), Example 6 (LC-6), and Example 7 (LC-7) have high T_{NI} and low T_{CN}, and thus have a wide nematic phase transition temperature range, and also have large Δn, negative large Δε, small γ₁, large K₁₁, large K₃₃, and small γ₁/K₃₃ correlated with the response speed of a liquid crystal display device, and thus the liquid crystal compositions of these examples are excellent and satisfy the physical properties required for a liquid crystal display device. In addition, FFS-mode liquid crystal display devices produced by using the liquid crystal compositions of these examples simultaneously satisfied the high response speed, high VHR, and excellent low-temperature storage stability, and no occurrence of display defects in the liquid crystal display device was confirmed. Similarly, it was confirmed that in VA-mode and IPS-mode liquid crystal display devices produced by using the liquid crystal compositions, the problem of the present invention is solved.

A liquid crystal composition of Example 8 (LC-8) was prepared and the physical property values thereof were measured. The component ratio and physical property values of the liquid crystal composition are as shown in Table 4.

TABLE 4

| | General | Example 8 |
|---|---|---|
| Molecular structure | Formula | LC-8 |
| 3-Cy-Cy-V | S1 | 40 |
| 3-Cy-Ph5-O2 | S2 | 19 |
| 3-Cy-Cy-1O-Ph5-O2 | S3 | 10 |
| 1V-Cy-Cy-1O-Ph5-O2 | S3 | 8 |
| 1-Ph-2-Ph-Ph5-O2 | N-04-1 | 7 |
| 3-Cy-Ph-Ph-2 | NU-05 | 8 |
| V-Cy-Ph-Ph-3 | NU-05 | 8 |
| 3-Cy-1O-Ph5-O2 | — | — |
| 3-Cy-Ph-Ph5-O2 | N-03 | — |
| 1-Ph-Ph-2-Ph-1 | — | — |
| 3-Ph-Ph-2-Ph-1 | — | — |
| 3-Cy-Ph3-Ph-2-Ph-1 | — | — |
| 3-Cy-Ph3-Ph-2-Ph-3 | — | — |
| Total [%] | | 100 |
| T_{NI} [° C.] | | 75 |
| T_{CN} [° C.] | | −31 |
| Δn | | 0.098 |
| Δε | | −2.6 |
| γ₁ [mPa•s] | | 92 |
| K₁₁ [pN] | | 13.6 |
| K₃₃ [pN] | | 15.4 |
| γ₁/K₃₃ | | 6.0 |
| VHR [%] | | 98 |
| LTS | | OK |

Example 8 (LC-8) had excellent physical properties and a liquid crystal display device exhibited small γ₁/K₃₃ correlated with the response speed of a liquid crystal display device, and a sufficiently high VHR.

In addition, when each of the liquid crystal compositions of Examples 1 to 8 contained 0.3% of a polymerizable compound represented by the general formula (RM-1), and a PSA-mode or PSVA-mode liquid crystal display device was formed, it was confirmed that the problem of the present invention is solved. In detail, in the general formula (RM-4), R^{M1} and R^{M2} each represent an alkyl group having 1 carbon atom.

In addition, when each of the liquid crystal compositions of Examples 1 to 8 contained 0.4% of a polymerizable compound represented by the general formula (RM-2), and a PSA-mode or PSVA-mode liquid crystal display device was formed, it was confirmed that the problem of the resent invention is solved. In detail, in the general formula (RM-4), R^{M1} and R^{M2} each represent an alkyl group having 1 carbon atom.

In addition, each of the liquid crystal compositions of Examples 1 to 8 contained 0.5% of a polymerizable compound represented by the general formula (RM-4), and a PSA-mode or PSVA-mode liquid crystal display device was formed, it was confirmed that the problem of the resent invention is solved. In detail, in the general formula (RM-4), R^{M1} and R^{M2} each represent an alkyl group having 1 carbon atom.

A composition was prepared by further adding 30 ppm by mass of a compound represented by the formula (H-11) as the antioxidant to each of the polymerizable compound-containing liquid crystal compositions, and evaluated as described above. As a result, it was confirmed that the problem of the resent invention is solved.

A composition was prepared by further adding 30 ppm by mass of a compound represented by the formula (H-14) as the antioxidant to each of the polymerizable compound-containing liquid crystal compositions, and evaluated as described above. As a result, it was confirmed that the problem of the resent invention is solved.

In addition, 200 ppm by mass of a hindered amine-based light stabilizer, Tinuvin 770, as added to each of the liquid crystal compositions of Examples 1 to 8, and a FFS-mode liquid crystal display device was formed. As a result, it was confirmed that the problem of the resent invention is solved. It was also confirmed that when LA-57 is used, the same results are exhibited.

Further, as a comparison with Example 1 (LC-1), liquid crystal compositions of Comparative Example 3 (LC-C), Comparative Example 4 (LC-D), and Comparative Example 5 (LC-E) were prepared, and the physical property values thereof were measured. The component ratios and physical property values of the liquid crystal compositions are as shown in Table 5.

TABLE 5

| | | | Comparative | Comparative | Comparative |
|---|---|---|---|---|---|
| | General | Example 1 | Example 3 | Example 4 | Example 5 |
| Molecular structure | Formula | LC -1 | LC-C | LC-D | LC-E |
| 3-Cy-Cy-V | S1 | 37 | — | 37 | 37 |
| 3-Cy-Ph5-O2 | S2 | 10 | 10 | 10 | — |
| 5-Cy-Ph5-O2 | S2 | 5 | 5 | 5 | — |
| 2-Cy-Cy-1O-Ph5-O2 | S3 | 12 | 12 | — | 12 |
| 3-Cy-Cy-1O-Ph5-O2 | S3 | 12 | 12 | — | 12 |
| 2-Ph-2-Ph-Ph5-O2 | N-04-1 | 6 | 6 | 6 | 6 |
| 3-Ph-2-Ph-Ph5-O2 | N-04-1 | 6 | 6 | 6 | 6 |
| 3-Cy-Ph-Ph-2 | NU-05 | 6 | 6 | 6 | 6 |
| V-Cy-Ph-Ph-3 | NU-05 | 6 | 6 | 6 | 6 |
| 3-Cy-1O-Ph5-O1 | — | — | — | 12 | 10 |
| 3-Cy-1O-Ph5-O2 | — | — | — | 12 | 5 |
| 3-Cy-Cy-2 | NU-01 | — | 25 | — | — |
| 3-Cy-Cy-4 | NU-01 | — | 12 | — | — |
| 3-Ph-Ph-1 | NU-03 | — | — | — | — |
| 3-Cy-Cy-Ph-1 | NU-04 | — | — | — | — |
| Total [%] | | 100 | 100 | 100 | 100 |
| T_{NI} | | 78 | 79 | 44 | 77 |
| T_{CN} | | −59 | −21 | −30 | −24 |
| Δn | | 0.099 | 0.095 | 0.087 | 0.098 |
| Δε | | −3.2 | −3.1 | −3.0 | −3.6 |
| γ₁ | | 102 | 121 | 56 | 107 |
| VHR(UV) | | 97 | 97 | 66 | 73 |

It was confirmed that FFS-mode and VA-mode liquid crystal display devices produced by using Comparative Example 3 (LC-C) have a remarkably low response speed which is a response speed lower by about 13% than that of Example 1 (LC-1). It was also confirmed that this example exhibits high T_{CN}, and low-temperature storage stability “NG”. Therefore, it was confirmed that the high response speed, high VHR, and excellent low-temperature storage stability are not simultaneously satisfied.

It was confirmed that FFS-mode and VA-mode liquid crystal display devices produced by using Comparative Example 4 (LC-D) have a remarkably high response speed, but have remarkably low T_{NI}, remarkably low Δn, and further remarkably low VHR, and that the high response speed, high VHR, and excellent low-temperature storage stability are not simultaneously satisfied.

It was confirmed that FFS-mode and VA-mode liquid crystal display devices produced by using Comparative Example 5 (LC-E) have high T_{CN}, low-temperature storage stability “NG”, and remarkably low VHR. Therefore, it was confirmed that the high response speed, high VHR, and excellent low-temperature storage stability are not simultaneously satisfied.

That is, it was confirmed that the liquid crystal composition of Example 1 (LC-1) simultaneously satisfies the high response speed, high VHR, and excellent low-temperature storage stability, which is the problem of the present invention.

Thus, it was confirmed that the liquid crystal composition of the present invention resolves the problem.

Further, Example 9 (LC-9) and Example 10 (LC-10) were prepared and the characteristics thereof were confirmed.

TABLE 6

| | General | Example 9 |
|---|---|---|
| Molecular structure | Formula | LC-9 |
| 3-Cy-Cy-V | S1 | 37 |
| 3-Cy-Ph5-O2 | S2 | 10 |
| 5-Cy-Ph5-O2 | S2 | 5 |
| 2-Cy-Cy-1O-Ph5-O2 | S3 | 12 |
| 3-Cy-Cy-1O-Ph5-O2 | S3 | 12 |
| 2-Ph-2-Ph-Ph5-O2 | N-04-1 | — |
| 3-Ph-2-Ph-Ph5-O2 | N-04-1 | — |
| 3-Cy-Ph-Ph-2 | NU-05 | 6 |
| V-Cy-Ph-Ph-3 | NU-05 | 6 |
| 3-Cy-1O-Ph5-O1 | — | — |
| 3-Cy-1O-Ph5-O2 | — | — |
| 2-Cy-Ph-Ph5-O2 | N-03 | 6 |
| 3-Cy-Ph-Ph5-O2 | N-03 | 6 |
| Total [%] | | 100 |
| T_{NI} [° C.] | | 84 |
| T_{CN} [° C.] | | −58 |
| Δn | | 0.096 |
| Δε | | −3.2 |
| γ₁ [mPa•s] | | 114 |
| K₁₁ [pN] | | 14.7 |
| K₃₃ [pN] | | 15.0 |
| γ₁/K₃₃ | | 7.6 |
| VHR [%] | | 97 |
| LTS | | OK |

TABLE 7

| | General | Example 10 |
|---|---|---|
| Molecular structure | Formula | LC-10 |
| 3-Cy-Cy-V | S1 | 40 |
| 3-Cy-Ph5-O2 | S2 | 12 |
| 3-Cy-Cy-1O-Ph5-O2 | S3 | 10 |
| 1V-Cy-Cy-1O-Ph5-O2 | S3 | 8 |
| 1-Ph-2-Ph-Ph5-O2 | N-04-1 | 4 |
| 3-Cy-Ph-Ph-2 | NU-05 | — |
| V-Cy-Ph-Ph-3 | NU-05 | — |
| 3-Cy-1O-Ph5-O2 | — | 7 |
| 3-Cy-Ph-Ph5-O2 | N-03 | 3 |
| 1-Ph-Ph-2-Ph-1 | — | 4 |
| 3-Ph-Ph-2-Ph-1 | — | 4 |
| 3-Cy-Ph3-Ph-2-Ph-1 | — | 4 |
| 3-Cy-Ph3-Ph-2-Ph-3 | — | 4 |
| Total [%] | | 100 |
| T_{NI} [° C.] | | 77 |
| T_{CN} [° C.] | | −27 |
| Δn | | 0.100 |
| Δε | | −2.9 |
| γ₁ [mPa•s] | | 104 |
| K₁₁ [pN] | | 15.0 |
| K₃₃ [pN] | | 17.7 |
| γ₁/K₃₃ | | 5.9 |
| VHR [%] | | 77 |

Further, a liquid crystal composition of Example 11 (LC-11) was prepared and the physical property values thereof were measured. The component ratio and physical property values of the liquid crystal composition are as follows.

TABLE 8

| | General | Example 11 |
|---|---|---|
| Molecular structure | Formula | LC-11 |
| 3-Cy-Cy-V | S1 | 29 |
| 3-Cy-Ph5-O2 | S2 | 10 |
| 5-Cy-Ph5-O2 | S2 | 5 |
| 2-Cy-Cy-1O-Ph5-O2 | S3 | 12 |
| 3-Cy-Cy-1O-Ph5-O2 | S3 | 12 |
| 2-Ph-2-Ph-Ph5-O2 | N-04-1 | 6 |
| 3-Ph-2-Ph-Ph5-O2 | N-04-1 | 6 |
| 3-Cy-Ph-Ph-1 | NU-05 | 3 |
| 3-Cy-Ph-Ph-2 | NU-05 | 3 |
| V-Cy-Ph-Ph-3 | NU-05 | 6 |
| 3-Cy-Cy-V1 | NU-01 | 8 |
| Total [%] | | 100 |
| T_{NI} [° C.] | | 81 |
| T_{CN} [° C.] | | −55 |
| Δn | | 0.101 |
| Δε | | −3.1 |
| γ₁ [mPa•s] | | 109 |
| K₁₁ [pN] | | 15.0 |
| K₃₃ [pN] | | 15.9 |
| γ₁/K₃₃ | | 6.9 |
| VHR [%] | | 97 |
| LTS | | OK |

Example 11 (LC-11) showed high T_{NI} and low T_{CN}, and thus had a wide nematic phase transition temperature range, and also had large Δn, negative Δε and high absolute value thereof, small γ₁, large K₁₁, large K₃₃, and small γ₁/K₃₃ correlated with the response speed. In addition, FFS-mode and VA-mode liquid crystal display devices produced by using the liquid crystal composition satisfied the high response speed, high VHR, and excellent low-temperature storage stability, and no occurrence of display defects was confirmed. That is, the liquid crystal composition of Example 11 (LC-11) has excellent physical properties and thus can solve the problem of the present invention.

1. A liquid crystal composition with negative dielectric anisotropy (Δε), comprising one or two or more compounds represented by general formula (S1), one or two or more compounds represented by general formula (S2), and one or two or more compounds represented by general formula (S3), 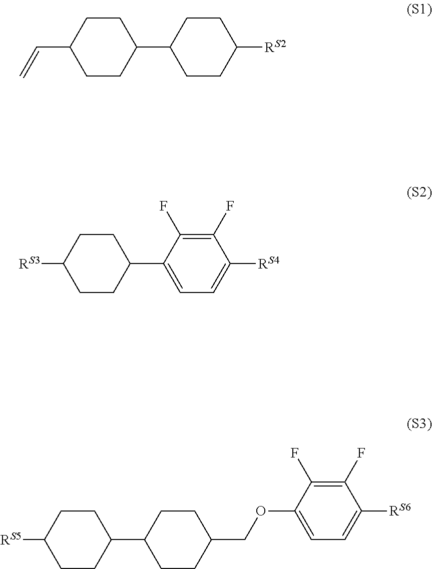
(in the formulae, R^{S2} to R^{S6} each independently represent an alkyl group having 1 to 8 carbon atoms, an alkoxy group having 1 to 8 carbon atoms, an alkenyl group having 2 or 3 carbon atoms, or an alkenyloxy group having 2 or 3 carbon atoms).

2. The liquid crystal composition according to claim 1, further comprising one or two or more compounds selected from a compound group represented by general formulae (N-01), general formula (N-02), general formula (N-03), and general formula (N-04), 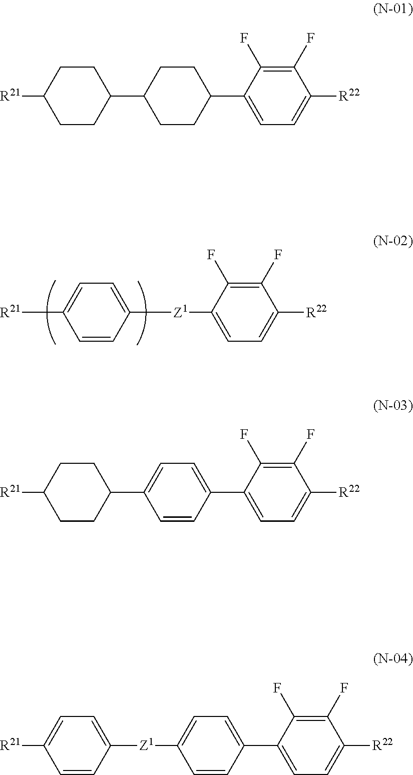
(in the formulae, R²¹ and R²² each independently represent an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, in which one or two or more unadjacent —CH₂— in the group may be independently substituted by —CH═CH—, —C≡C—, —O—, —CO—, —COO—, or —OCO—, Z¹ each independently represent a single bond, —CH₂CH₂—, —OCH₂—, —CH₂O—, —COO—, —OCO—, —OCF₂—, —CF₂O—, —CH═CH—, —CF═CF—, or —C≡C—; and m each independently represent 1 or 2, but exclude compounds represented by the general formulae (S2) and (S3)).

3. The liquid crystal composition according to claim 1, further comprising one or two or more compounds selected from a compound group represented by general formula (NU-01) to general formula (NU-06), 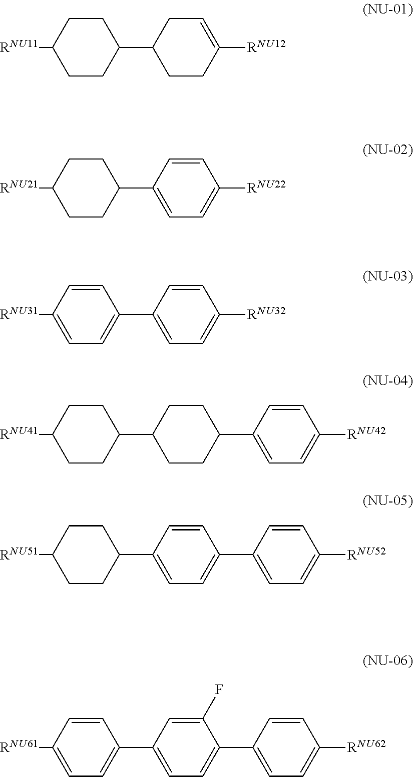
(in the formulae, R^{NU11}, R^{NU12}, R^{NU21}, R^{NU22}, R^{NU31}, R^{NU32}, R^{NU41}, R^{NU42}, R^{NU51}, R^{NU52}, R^{NU61}, and R^{NU62} each independently represent an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, in which one or two or more unadjacent —CH₂— in the group may be independently substituted by —CH═CH—, —C≡C—, —O—, —CO—, —COO—, or —OCO—; but exclude a compound represented by the general formula (S1)).

4. The liquid crystal composition according to claim 3, wherein the total content of the compounds contained in the liquid crystal composition and represented by the general formula (S1), the general formula (S2), the general formula (S3), the general formula (N-01), the general formula (N-02), the general formula (N-03), the general formula (N-04), the general formula (NU-01), the general formula (NU-02), the general formula (NU-03), the general formula (NU-04), the general formula (NU-05), and the general formula (NU-06) is 85% by mass to 100% by mass relative to the total of the composition.

5. The liquid crystal composition according to claim 1, comprising one or two or more compounds having a terphenyl structure or a tetraphenyl structure and a dielectric anisotropy (Δε) of more than +2.

6. The liquid crystal composition according to claim 2, comprising, as the compound represented by the general formula (N-04), one or two or more compounds represented by general formula (N-04-1), 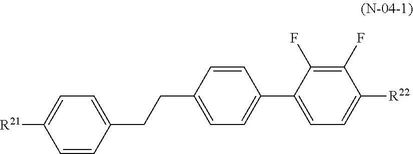
(in the formula, R²¹ and R²² each independently represent an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, in which one or two or more unadjacent —CH₂— in the group may be independently substituted by —CH═CH—, —C≡C—, —O—, —CO—, —COO—, or —OCO—).

7. The liquid crystal composition according to claim 3, comprising, as the compound represented by the general formula (NU-05), one or two or more compounds represented by general formula (NU-05-1) to formula (NU-05-10).

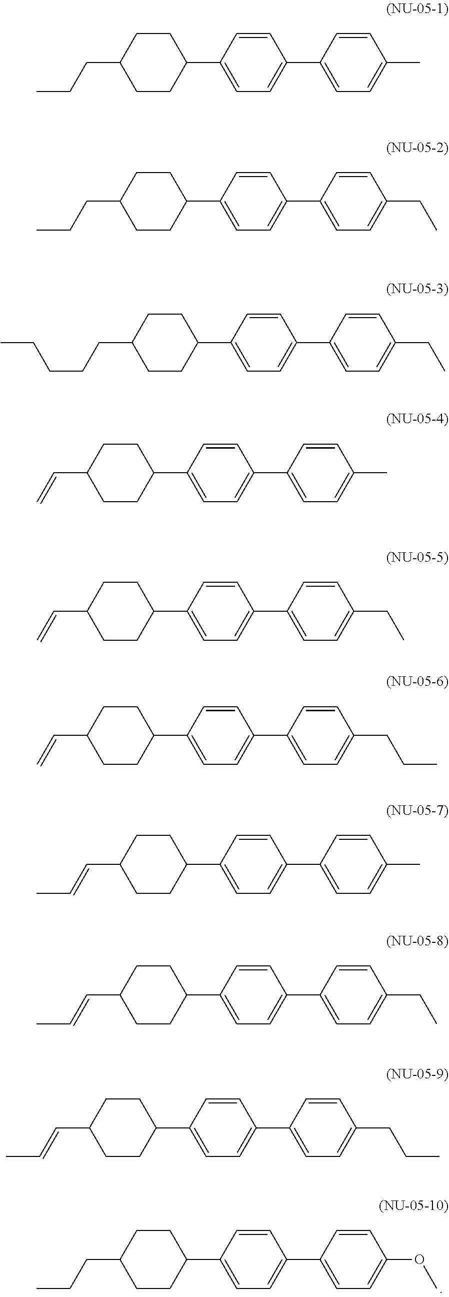

8. The liquid crystal composition according to claim 3, comprising 10% by mass to 50% by mass of the compound represented by the general formula (S1), 14% by mass to 34% by mass of the compound represented by the general formula (S2), 19% by mass to 39% by mass of the compound represented by the general formula (S3), 10% by mass to 30% by mass of the compound represented by the general formula (N-04-1), and 3% by mass to 30% by mass of the compound represented by the general formula (NU-05).

9. The liquid crystal composition according to claim 3, wherein the total content of the compounds contained in the liquid crystal composition and represented by the general formula (S1), the general formula (S2), the general formula (S3), the general formula (N-04-1), and the general formula (NU-05) is 85% by mass to 100% by mass relative to the total of the composition.

10. A liquid crystal display device comprising the liquid crystal composition according to claim 1.

11. A liquid crystal display device for active matrix driving, comprising the liquid crystal composition according to claim 1.

12. A VA-mode, IPS-mode, FFS-mode, PSA-mode, or PSVA-mode liquid crystal display device comprising the liquid crystal composition according to claim 1.
